(19) United States
(12) Patent Application Publication
(10) Pub. No.: US 2016/0357327 A1
(43) Pub. Date: Dec. 8, 2016

(54) TOUCH SENSITIVE SYSTEM AND APPARATUS AND METHOD FOR MEASURING SIGNALS OF TOUCH SENSITIVE SCREEN

(71) Applicant: EGALAX_EMPIA TECHNOLOGY INC., Taipei City (TW)

(72) Inventors: CHIN-FU CHANG, Taipei City (TW); SHANG-TAI YEH, Taipei City (TW)

(21) Appl. No.: 15/241,552

(22) Filed: Aug. 19, 2016

Related U.S. Application Data
(63) Continuation-in-part of application No. 13/896,487, filed on May 17, 2013.
Application No. 13/896,487 is a continuation-in-part of application No. 13/545,291, filed on Jul. 10, 2012, now Pat. No. 9,024,911.
(60) Provisional application No. 61/676,354, filed on Jul. 27, 2012.
(60) Provisional application No. 61/648,710, filed on May 18, 2012.

(30) Foreign Application Priority Data
Aug. 21, 2015 (TW) 104127423

(51) Int. Cl. G06F 3/041; G06F 3/044

(52) U.S. Cl. CPC G06F 3/0416; G06F 3/044; G06F 2203/04111

(57) ABSTRACT

The present invention provides an apparatus for measuring signals of touch sensitive screen, which comprises multiple conductive strips including multiple parallel driving strips and multiple parallel sensing strips. Multiple intersecting areas are located at the intersections of these multiple driving and sensing strips. The apparatus comprises a driving circuit and a sensing circuit. The driving circuit sequentially provides a first driving signal and a second driving signal to a first set of the driving strips and a second set of the driving strips, respectively. The sensing circuit sequentially senses a first signal and a second signal of at least one sensing strips corresponding to the first driving signal and the second driving signal, respectively. The time duration of the first driving signal is different from the time duration of the second driving signal.

### CROSS REFERENCE TO RELATED APPLICATIONS

This application claims the benefit of Taiwan patent application, No. 104127423 filed on Aug. 21, 2015 and this application is also a continuation-in-part of application Ser. No. 13/896,487, filed on May 17, 2013, which is a continuation-in-part of application Ser. No. 13/545,291, filed on Jul. 10, 2012, which claims the benefit of U.S. Provisional Application No. 61/648,710, filed on May 18, 2012. Application Ser. No. 13/896,487 also claims the benefit of U.S. Provisional Application No. 61/676,354, filed on Jul. 27, 2012, and the benefit of U.S. Provisional Application No. 61/648,710, filed on May 18, 2012. All of the above-referenced applications are hereby incorporated herein by reference in their entirety.

### BACKGROUND OF THE INVENTION

1. Field of the Invention

The present invention relates to a touch screen, and more particularly, to a technology for leveling touch screen with controlling the parameters of front-end module.

2. Description of the Prior Art

Touch panel or touch screen has already been one of the main input/output devices for the modern electronical apparatuses. In the present invention, the term of touch screen is used to represent the touch panel without display or the touch screen with display. Capacitive touch screen determines the locations of touches made by a human body thereon based on changes in detected signals due to its capacitive coupling with the body. When the human touches the screen, noise surrounding the human body also adds to the capacitive coupling between the human body and the capacitive touch screen, and thus causing changes in the detected signals. Moreover, since noise is not constant, it cannot be easily determined. When the signal to noise ratio (S/N ratio) is relatively small, a touch may not be detected, or the location of the touch may not be accurately detected.

In addition, the phase differences between the signals received by the detecting electrodes and the signals which will be provided to the driving electrodes will be resulted because the signals pass through load circuits such as capacitive coupling. When the periods of the driving signals are the same, the signals with different phases will be received at different times. If signals are measured after ignoring the phase differences, the measurements will be disturbed by the different initial phases. If the measurements corresponding to different electrodes are great inconsistent, the determination of the touch position is always incorrect.

Besides, the impedance of the RC circuit, to which the driving signals pass, corresponding to different driving electrodes could be different such that the image values of the touch panel will change roughly when the touch penal is detected in mutual-capacitive coupling.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

In one embodiment of the present invention, it provides an apparatus for measuring signals of touch sensitive screen. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit sequentially provides a first driving signal and a second driving signal to a first set of the driving strips and a second set of the driving strips, respectively. The sensing circuit sequentially senses a first signal and a second signal of at least one of sensing strips corresponding to the first driving signal and the second driving signal, respectively. Wherein, the time duration of the first driving signal is different from the time duration of the second driving signal.

In another embodiment of the present invention, it offers a method for measuring signals of touch sensitive screen. The touch sensitive screen includes multiple conductive strips having multiple parallel driving strips and multiple parallel sensing strips, wherein multiple intersecting areas are located at multiple intersections of the driving and sensing strips. The method includes sequentially providing a first driving signal and a second driving signal to a first set of the driving strips and a second set of the driving strips, respectively, and sequentially sensing a first signal and a second signal of at least one of sensing strips corresponding to the first driving signal and the second driving signal, respectively. Wherein, the time duration of the first driving signal is different from the time duration of the second driving signal.

In one embodiment of the present invention, it provides an apparatus for measuring signals of touch sensitive screen. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit sequentially provides a first driving signal and a second driving signal to a first set of the driving strips and a second set of the driving strips, respectively. The sensing circuit sequentially senses a first signal and a second signal of at least one sensing strip corresponding to the first driving signal and the second driving signal, respectively. Wherein, at least one of the following conditions or any combination thereof is satisfied: the sensing circuit connecting the at least one sensing strip via a variable resistor, the variable resistor being set to a first resistance value as the sensing circuit generating the first signal, the variable resistor being set to a second resistance value as the sensing circuit generating the second signal, the first resistance value being different from the second resistance value; the sensing circuit using a first sensing time duration to produce the first signal, the sensing circuit using a second sensing time duration to produce the second signal, the first sensing time duration being different from the second sensing time duration; the sensing circuit connecting the at least one sensing strip via an amplifier, the amplifier being set to a first gain as the sensing circuit generating the first signal, the amplifier being set to a second gain as the sensing circuit generating the second signal, the first gain being different from the second gain; the sensing circuit producing the first signal after a first delay phase difference, the sensing circuit producing the second signal after a second delay phase difference, the first delay phase difference being different from the second delay phase difference; the potential of the first driving signal being different from the potential of the second driving signal; a first driving time point for providing the first driving signal being different from a second driving time point for providing the second driving signal; and the driving time duration of the first driving signal being different from the driving time duration of the second driving signal.

In another embodiment of the present invention, it offers a method for measuring signals of touch sensitive screen. The touch sensitive screen includes multiple conductive strips having multiple parallel driving strips and multiple parallel sensing strips, wherein multiple intersecting areas are located at multiple intersections of the driving and sensing strips. The method includes sequentially providing a first driving signal and a second driving signal to a first set of the driving strips and a second set of the driving strips, respectively, and sequentially sensing a first signal and a second signal of at least one of sensing strips corresponding to the first driving signal and the second driving signal, respectively. Wherein, at least one of the following conditions or any combination thereof is satisfied: the sensing circuit connecting the at least one sensing strip via a variable resistor, the variable resistor being set to a first resistance value as the sensing circuit generating the first signal, the variable resistor being set to a second resistance value as the sensing circuit generating the second signal, the first resistance value being different from the second resistance value; the sensing circuit using a first sensing time duration to produce the first signal, the sensing circuit using a second sensing time duration to produce the second signal, the first sensing time duration being different from the second sensing time duration; the sensing circuit connecting the at least one sensing strip via an amplifier, the amplifier being set to a first gain as the sensing circuit generating the first signal, the amplifier being set to a second gain as the sensing circuit generating the second signal, the first gain being different from the second gain; the sensing circuit producing the first signal after a first delay phase difference, the sensing circuit producing the second signal after a second delay phase difference, the first delay phase difference being different from the second delay phase difference; the potential of the first driving signal being different from the potential of the second driving signal; a first driving time point for providing the first driving signal being different from a second driving time point for providing the second driving signal; and the driving time duration of the first driving signal being different from the driving time duration of the second driving signal.

In one embodiment of the present invention, it provides a touch sensitive system including the abovementioned touch sensitive screen and apparatus for measuring signals of touch sensitive screen.

### BRIEF DESCRIPTION OF THE DRAWINGS

FIG. 1 and FIG. 4 are schematic diagrams illustrating capacitive touch screens and control circuits thereof according to the present invention;

FIG. 2A is a schematic diagram illustrating a single-electrode driving mode;

FIGS. 2B and 2C are schematic diagrams illustrating a two-electrode driving mode;

FIGS. 3A and 3B is a flowchart illustrating a detection method for the capacitive touch screen according to the present invention;

FIG. 5 is a schematic diagram illustrating the generation of a full image;

FIG. 6 is a schematic diagram illustrating the generation of a reduced image;

FIGS. 7A and 7B are schematic diagrams illustrating the generation of an expanded image;

FIG. 8 is a flowchart illustrating the generation of the expanded image according to the present invention;

FIGS. 9A and 9B are schematic diagrams illustrating the different phase differences produced from driving signals by different driving electrodes;

FIGS. 10 and 11 is a flowchart illustrating the detecting method of touch screen according to a first embodiment of the present invention;

FIG. 12 is a flowchart illustrating the detecting method of touch screen according to another embodiment of the present invention;

FIG. 13 illustrates a block diagram for one preferred touch system embodiment in accordance with the present invention;

FIGS. 14A-14D show signal-measuring methods of touch screen for preferred embodiments in accordance with the present invention;

FIG. 15 illustrates an electrode structure of touch screen for one preferred embodiment in accordance with the present invention;

FIG. 16 illustrates an electrode structure of touch screen for one preferred embodiment in accordance with the present invention;

FIG. 17 illustrates a part of electrode structure of touch screen for one preferred embodiment in accordance with the present invention; and

FIG. 18 illustrates a part of electrode structure of touch screen for one preferred embodiment in accordance with the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

Capacitive touch screens are vulnerable to noise, especially, that coming from the human body touching the screen. The present invention achieves the objective of reducing noise interference with an adaptive driving and/or detecting scheme.

In a capacitive touch screen, a plurality of electrodes arranged in rows and columns are used for detecting locations of the touches, in which power consumption is proportional to the number of simultaneously driven electrodes and the driving voltage. During touch detecting, noise may travel to the capacitive touch screen via the conductor touching the screen, degrading the signal to noise ratio (S/N ratio) and causing misjudgment of a touch or the location of a touch. In other words, the S/N ratio dynamically changes according to the object touching the screen as well as the surrounding environment.

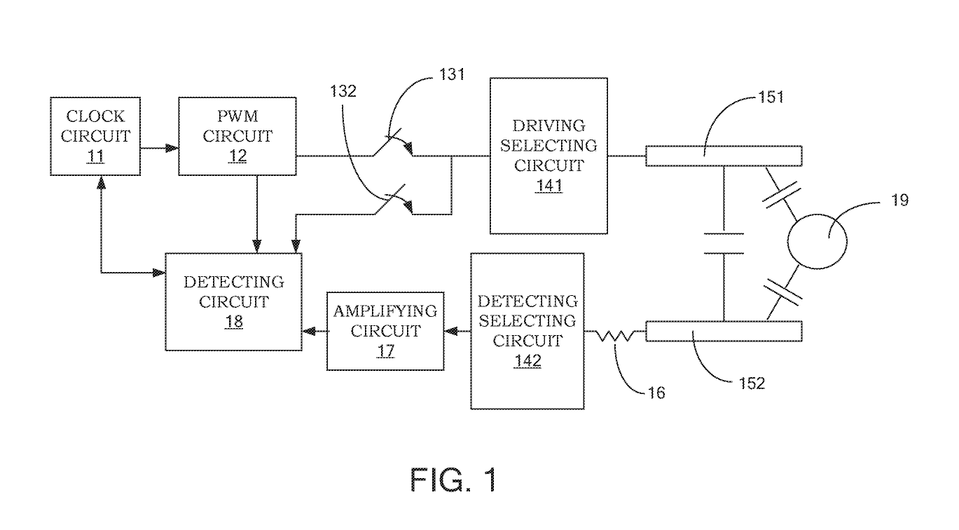

Referring to FIG. 1, a schematic diagram illustrating a capacitive touch screen and a control circuit thereof according to the present invention is shown. It includes a clock circuit 11, a pulse width modulation (PWM) circuit 12, a driving switch 131, a detecting switch 132, a driving selecting circuit 141, a detecting selecting circuit 142, at least one driving electrode 151, at least one detecting electrode 152, a variable resistor 16, an amplifying circuit 17 and a measuring circuit 18. The capacitive touch screen may include the plurality of driving electrodes 151 and the plurality of detecting electrodes 152 crossing each other to form a plurality of intersections.

The clock circuit 11 provides a clock signal for the entire system based on a working frequency, and the PWM circuit 12 provides a PWM signal based on the clock signal and a PWM parameter to drive the driving electrodes 151. The driving switch 131 control the driving of the driving electrodes 151, and the selecting circuit 141 selects at least one driving electrode 151. In addition, the detecting switch 132 controls the electrical coupling between the driving electrodes and the measuring circuit 18. When the driving switch 131 is turned on, the detecting switch 132 is turned off, the PWM signal is provided via the driving selecting circuit 141 to the driving electrode(s) 151 coupled by the driving selecting circuit 141, wherein there can be a plurality of driving electrodes 151, and the selected driving electrode(s) 151 can be one, two, or more. When a driving electrode 151 is driven by the PWM signal, capacitive coupling will be generated at intersections of detecting electrodes 152 and the driving electrode 151 being driven, and each detecting electrode 152 will generate an input signal when capacitively coupled to the driving electrode 151. The variable resistor 16 provides impedance based on a resistor parameter, and the input signal is provided to the detecting selecting circuit 142 via the variable resistor 16. The detecting selecting circuit 142 selects one, two, three, multiple or all of the detecting electrodes 152 to couple with the amplifying circuit 17. The input signal is amplified by the amplifying circuit 17 based on a gain parameter and then provided to the measuring circuit 18. The measuring circuit 18 detects the input signal based on the PWM signal and the clock signal, wherein the measuring circuit 18 samples the detected signal with at least one phase based on a phase parameter. The measuring circuit 18 can, for example, include at least one integration circuit. Each integration circuit performs integration on an input signal in the input signal with at least one phase based on the phase parameter to measure the magnitude of the input signal. In an example of the present invention, each integration circuit performs integration on the signal difference of a pair of input signals in the input signal with at least one phase based on the phase parameter, or performs integration on the difference between signal differences of two pairs of input signals in the input signal with at least one phase based on the phase parameter. Moreover, the measuring circuit 18 may further include at least one analog-to-digital converter (ADC) to convert the detection result into a digital signal. In addition, it can be appreciated by one with ordinary skill in the art that the input signal can be first amplified by the amplifying circuit 17 before providing to the measuring circuit 18 by the detecting selecting circuit 142; the present invention is not limited as such.

In the present invention, capacitive touch screens have at least two types of driving modes: a power saving single-electrode driving mode, and a two-electrode driving mode, and have at least one driving potential. Each driving mode corresponding to a different driving potential has at least one working frequency. Each working frequency corresponds to a set of parameters. Each driving mode corresponding to a different driving potential represents power consumption of a different level.

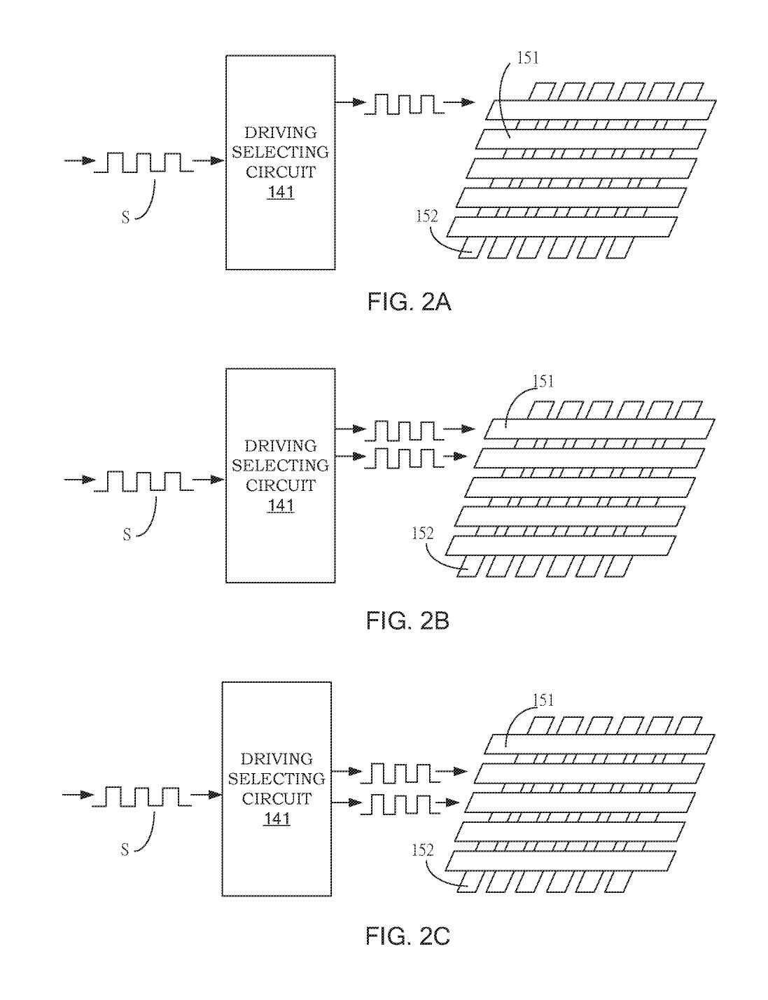

The electrodes of a capacitive touch screen are divided into a plurality of driving electrodes 151 and a plurality of detecting electrodes 152. The driving electrodes 151 and the detecting electrodes 152 cross each other at numerous intersections. Referring to FIG. 2A, in the single-electrode driving mode, driving electrodes 151 are driven one at a time, that is, in any one instance, only a single driving electrode 151 is provided with a driving signal S. When any driving electrode 151 is driven, signals of all of the detecting electrodes 152 are detected to generate one-dimensional (1D) sensing information. Accordingly, after all the driving electrodes 151 are driven, 1D sensing information corresponding to every driving electrode 151 is obtained, which together constitute a full image corresponding to all intersections.

Referring to FIGS. 2B and 2C, in the two-electrode driving mode, a pair of adjacent driving electrodes 151 is driven at a time. In other words, n driving electrodes 151 require n−1 times of driving. When any pair of driving electrodes 151 is driven, signals of all of the detecting electrodes 152 are detected to generate 1D sensing information. For example, first, as shown in FIG. 2B, a driving signal S is simultaneously provided to a first pair of driving electrodes 151. And, for example, if there are 5 driving electrodes 151, 4 times of drivings are required. Then, as shown in FIG. 2C, the driving signal S is simultaneously provided to a second pair of driving electrodes 151, and so on. Accordingly, after every pair (total of n−1 pairs) of driving electrodes 151 are driven, 1D sensing information corresponding to every pair of driving electrodes 151 is obtained, which together constitute a reduced image in comparison to the full image. The number of pixels of the reduced image is less than that of the pixels of the full image. In another example of the present invention, the two-electrode driving mode further includes perform single-electrode driving on electrodes at either end. When the electrodes at either end are driven, signals of all the detecting electrodes 152 are detected to generate 1D sensing information, together they provide two 1D sensing information, which form an expanded image with the reduced image. For example, 1D sensing information corresponding to either side is placed outside the two sides of the reduced image to form the expanded image.

It can be appreciated by one with ordinary skill in the art that the present invention may also include three-electrode driving mode, four-electrode driving mode and the like, and they will not be further illustrated to avoid redundancy.

The driving potential may include, but is not limited to, at least two driving potentials, such as a low driving potential and a high driving potential. A higher driving potential has a higher S/N ratio.

According to the above, in the single-electrode driving mode, a full image can be obtained, whereas in the two-electrode driving mode, a reduced image and an expanded image can be obtained. The full image, the reduced image and the expanded image can be obtained before or when an external conductive object 19 approaches or touches the capacitive touch screen to generate the variant quantity of each pixel for judging the location of the external conductive object 19. The external conductive object 19 can be one or more. As mentioned before, when the external conductive object 19 approaches or touches the capacitive touch screen, or capacitive couples with the driving electrode(s) 151 and the detecting electrode(s) 152, noise interference may arise, even when the driving electrode 151 is not driven, the external conductive object 19 may still capacitive couple with the driving electrode(s) 151 and the detecting electrode(s) 152. Moreover, noise may interfere through some other routes.

Accordingly, the present invention provides a noise detecting process for detecting noise interference. During the noise detecting process, the driving switch 131 is turned off, and the detecting switch 132 is turned on, such that the measuring circuit can generate 1D sensing information of noise detection based on the signals of the detecting electrodes 152, thereby determining if the noise interference is within a tolerable range. For example, whether the noise interference being within the tolerable range can be determined by determining whether any value in the 1D sensing information of noise detection exceeds a threshold, or whether the sum or the average of all the values of the 1D sensing information of noise detection exceeds a threshold. It can be appreciated by one with ordinary skill in the art that there are other ways of determining whether the noise interference is within the tolerable range based on the 1D sensing information of noise detection, which the present invention will not further illustrate.

The noise detecting process can be performed when the system is activated, or every time the full, the reduced, or the expanded image is obtained, or regularly or multiple times when the full, the reduced, or the expanded image is obtained, or when an approaching or touch by an external conductive object being detected. It can be appreciated by one with ordinary skill in the art that there are other suitable timings for performing the noise detecting process; the present invention is not limited to these.

The present invention further proposes a frequency switching process for switching frequencies when the noise interference exceeds the tolerable range. The measuring circuit is provided with several sets of frequency settings, which can be stored in a memory or other storage media and can be selected by the measuring circuit during the frequency switching process. The clock signal of the clock circuit 11 is thus controlled by the selected frequency. The frequency switching process may include selecting a suitable frequency setting from the frequency settings, for example, sequentially using a set of frequency setting and performing the noise detecting process until the noise interference being within the tolerable range. The frequency switching process may alternatively include selecting the best frequency setting from the frequency settings, for example, sequentially using a set of frequency setting and performing the noise detecting process, and selecting the frequency setting with the least noise interference, for example, the frequency setting with the smallest maximum value of the 1D sensing information of noise detection, or the frequency setting with the smallest sum or average of all the values of the 1D sensing information of noise detection.

The frequency settings include, but are not limited to, a driving mode, a frequency and a set of parameters. The set of parameters may include, but is not limited to, the resistor parameter, the gain parameter, the phase parameter and the PWM parameter. It can be appreciated by one with ordinary skill in the art that there are other parameters suitable for the capacitive touch screen and its control circuit.

The frequency settings may include a plurality of driving potentials, such as a first driving potential and a second driving potential, as shown in Table 1 below. It can be appreciated by one with ordinary skill in the art that there can be three or more driving potentials. Each driving potential can be divided into several driving modes, including, but not limited to, single-electrode driving mode, two-electrode driving mode, three-electrode driving mode, four-electrode driving mode etc. Each driving mode of each driving potential includes a plurality of frequencies, each frequency corresponds to a set of parameters just mentioned. It can be appreciated by one with ordinary skill in the art that the frequencies of each driving mode corresponding to each driving potential may be entirely different, or partially the same; the present invention is not limited as such.

TABLE 1

| Driving | Driving | | Parameter |
|---|---|---|---|
| Potential | Mode | Frequency | Set |
| First | Single-electrode | First | First parameter |
| driving | driving mode | frequency | set |
| potential | | First | First parameter |
| | | frequency | set |
| | | . . . | |
| | | i^{th} | i^{th} parameter |
| | | frequency | set |
| | Two-electrode | (i + 1)^{th} | (i + 1)^{th} parameter |
| | driving mode | frequency | set |
| | | (i + 2)^{th} | (i + 2)^{th} parameter |
| | | frequency | set |
| | | . . . | |
| | | j^{th} | j^{th} parameter |
| | | frequency | set |
| Second | Single-electrode | (j + 1)^{th} | (j + 1)^{th} parameter |
| driving | driving mode | frequency | set |
| potential | | (j + 2)^{th} | (j + 2)^{th} parameter |
| | | frequency | set |
| | | . . . | |
| | | k^{th} | k^{th} parameter |
| | | frequency | set |
| | Two-electrode | (k + 1)^{th} | (k + 1)^{th} parameter |
| | driving mode | frequency | set |
| | | (k + 2)^{th} | (k + 2)^{th} parameter |
| | | frequency | set |

| . . . | |
|---|---|
| n^{th} | n^{th} parameter |
| frequency | set |

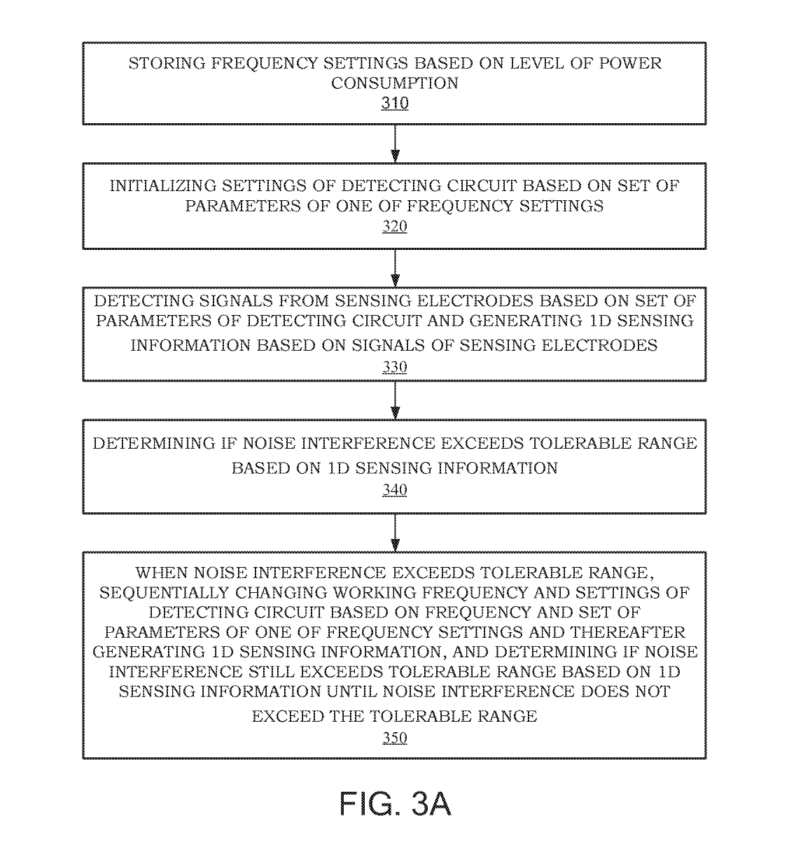

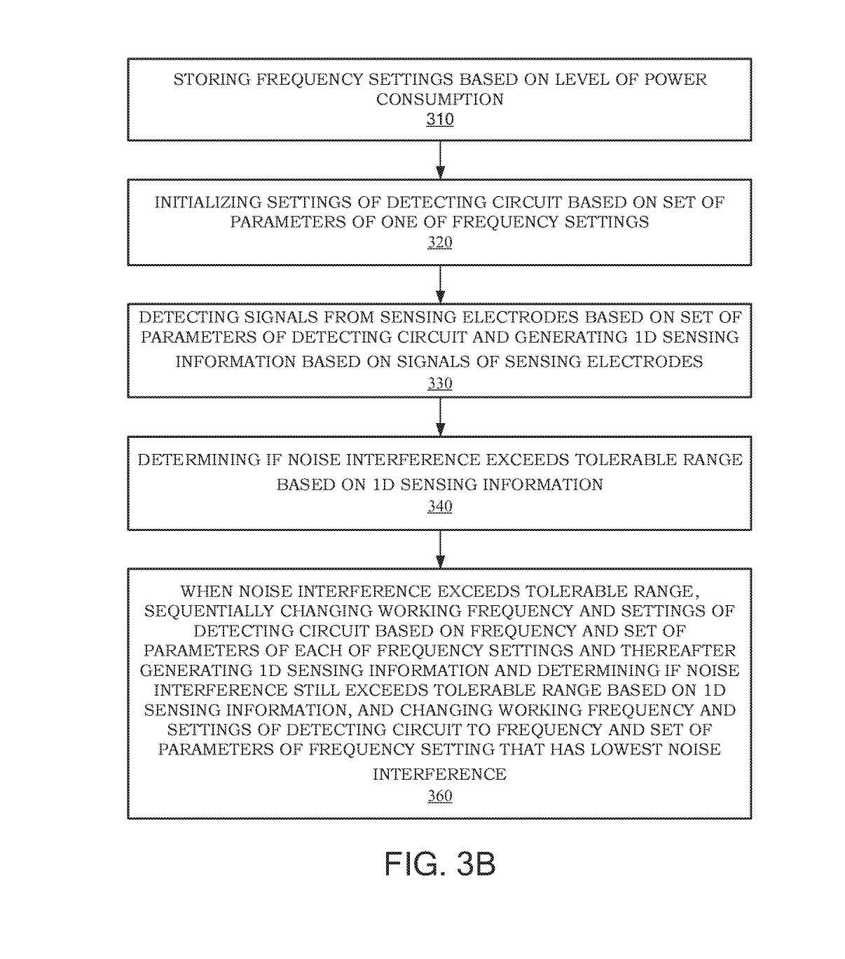

According to the above, the present invention proposes a detecting method for the capacitive touch screen. Referring to FIG. 3A, first, in step 310, a plurality of frequency settings are sequentially stored based on the levels of power consumption. Each frequency setting corresponds to a driving mode of a driving potential, and each frequency setting has a frequency and a set of parameters, wherein there are at least one type of driving potential. Next, in step 320, the setting of the detecting circuit is initialized based on the set of parameter of one of the frequency settings, and in step 330, signals of the detecting electrodes are detected by the detecting circuit based on a set of parameters of the detecting circuit, and 1D sensing information is generated from the signals of the detecting electrodes. Then, in step 340, it is determined whether noise interference exceeds a tolerable range based on the 1D sensing information. Thereafter, in step 350, when the noise interference exceeds the tolerable range, the working frequency and the setting of the detecting circuit are changed according to the frequency and the set of parameter of one of the frequency settings, and 1D sensing information is generated, and then it is again determined whether the noise interference exceeds the tolerable range based on the 1D sensing information. This step is repeated until the noise interference is within the tolerable range. Alternatively, in step 360 of FIG. 3B, when the noise interference exceeds the tolerable range, the working frequency and the setting of the detecting circuit are changed according to the frequency and the set of parameter of every of the frequency settings, and 1D sensing information is generated and then the noise interference is determined based on the 1D sensing information, and the working frequency and the setting of the detecting circuit are changed to the frequency and the set of parameter of the frequency setting that is least interfered by noise.

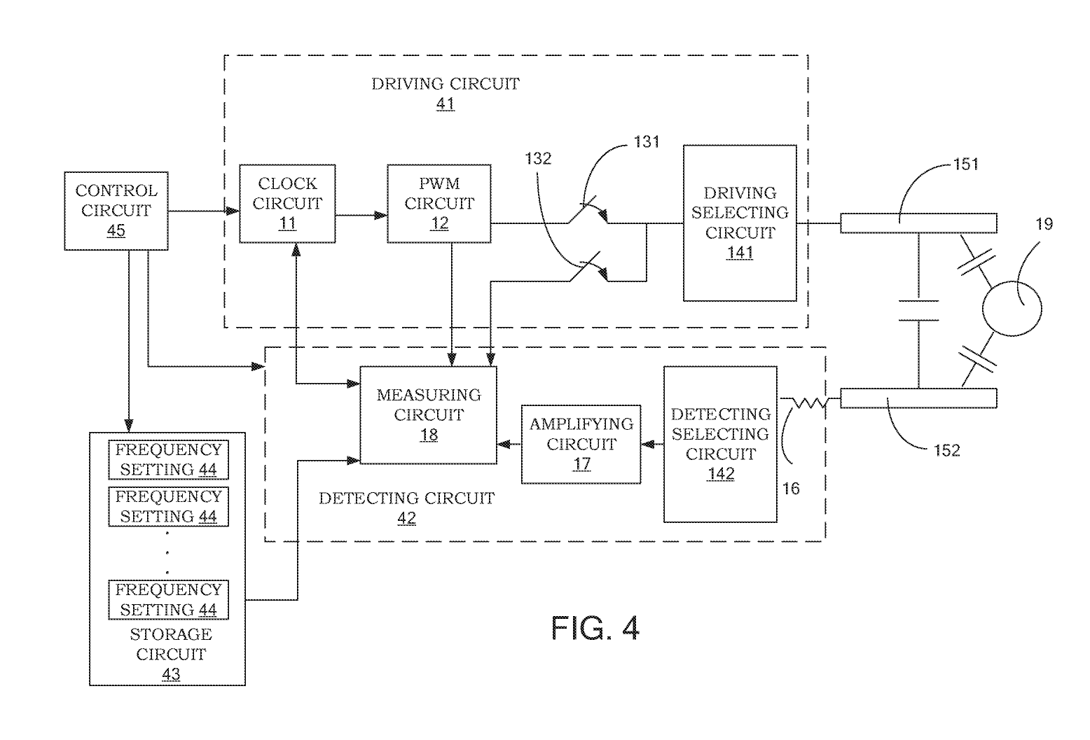

For example, as shown in FIG. 4, a detecting device for detecting a capacitive touch screen is proposed according to a best mode of the present invention, which includes a storage circuit 43, a driving circuit 41 and a detecting circuit 42. As described in step 310, the storage circuit 43 includes a plurality of frequency settings 44 sequentially stored according to the levels of power consumption. The storage circuit 43 can be a circuit, a memory or a storage media capable of storing electromagnetic records. In an example of the present invention, the frequency settings 44 can be implemented as a lookup table. In addition, the frequency settings 44 can also store a power consumption parameter.

The driving circuit 41 can be an integration of several circuits, including, but not limited to, the clock circuit 11, the PWM circuit 12, the driving switch 131, the detecting switch 132 and the driving selecting circuit 141. The circuits listed in this example is merely for illustration purpose, and the driving circuit 41 may only include some of the circuits or add more circuits; the present invention is not limited as such. The driving circuit 41 is used to provide a driving signal to at least one driving electrode 151 of a capacitive touch screen according to a working frequency, wherein the capacitive touch screen includes a plurality of driving electrodes 151 and a plurality of detecting electrodes 152, and the driving electrodes 151 intersect the detecting electrodes 152 to form a plurality of intersections.

The detecting circuit 42 can be an integration of several circuits, including, but not limited to, the measuring circuit 18, the amplifying circuit 17, the detecting selecting circuit 142, and even the variable resistor 16. The circuits listed in this example is merely for illustration purpose, and the detecting circuit 42 may only include some of the circuits or add more circuits; the present invention is not limited as such. Furthermore, the detecting circuit 42 may further include performing the steps 320 to 340, and step 350 or step 360. In the example of FIG. 3B, the frequency settings are not necessarily stored sequentially according to the levels of power consumption.

As previously described, the 1D sensing information for determining whether the noise interference exceeds the tolerable range is generated when no driving signal is provided to the driving electrode(s) 151, for example, when the driving switch 131 is turned off and the detecting switch 132 is turned on.

In an example of the present invention, the at least one driving potential has several types of driving modes, including a single-electrode driving mode and a two-electrode driving mode. In the single-electrode driving mode, the driving signal is provided to only a single driving electrode at any instance, while in the two-electrode driving mode, the driving signal is provided to a pair of driving electrodes simultaneously. The level of power consumption of the single-electrode driving mode is less than the level of power consumption in the two-electrode driving mode. In addition, in the single-electrode driving mode, when every driving electrode is driven by the driving signal, 1D sensing information is generated by the detecting circuit to constitute a full image. In the two-electrode driving mode, when every pair of driving electrodes is driven by the driving signal, 1D sensing information is generated by the detecting circuit to constitute a reduced image. The number of pixels of the reduced image is less than that of the pixels of the full image. Moreover, in the two-electrode driving mode, the detecting circuit may further perform single-electrode driving on electrodes at either end. When the electrodes at either end are driven, signals of all the detecting electrodes are detected to generate 1D sensing information, wherein the 1D sensing information for the electrodes at either side are placed outside the two sides of the reduced image to form the expanded image, and the number of pixels of the expanded image is greater than that of the pixels of the full image.

In another example of the present invention, the driving potential includes a first driving potential and a second driving potential, wherein the level of power consumption for generating the full image in the single-electrode driving mode of the first driving potential>the level of power consumption for generating the reduced image in the two-electrode driving mode of the first driving potential>the level of power consumption for generating the full image in the single-electrode driving mode of the second driving potential.

In yet another example of the present invention, the driving potential includes a first driving potential and a second driving potential, wherein the level of power consumption for generating the full image in the single-electrode driving mode of the first driving potential>the level of power consumption for generating the full image in the single-electrode driving mode of the second driving potential.

Moreover, in an example of the present invention, the signal of each detecting electrode is passed through a variable resistor before providing to the detecting circuit. The detecting circuit sets the impedance of the variable resistor according to the set of parameter of one of the frequency settings. In addition, the signals of the detecting electrodes are first amplified by at least one amplifier before being detected. The detecting circuit sets the gain of the amplifier according to the set of parameter of one of the frequency settings. In addition, the driving signal is generated according to the set of parameter of one of the frequency settings.

In an example of the present invention, each value of 1D sensing information is generated according to the signals of the detecting electrodes in a defined period, wherein the defined period is determined according to the set of parameter of one of the frequency settings. In an example of the present invention, each value of 1D sensing information is generated according to the signals of the detecting electrodes with at least one defined phase, wherein the defined phase is determined according to the set of parameter of one of the frequency settings.

In addition, the driving circuit 41, the detecting circuit 42 and the storing circuit 43 could be controlled by a control circuit 45. The control circuit 45 could be a programmable controller or any other type of control circuit, the present invention is not limited as such.

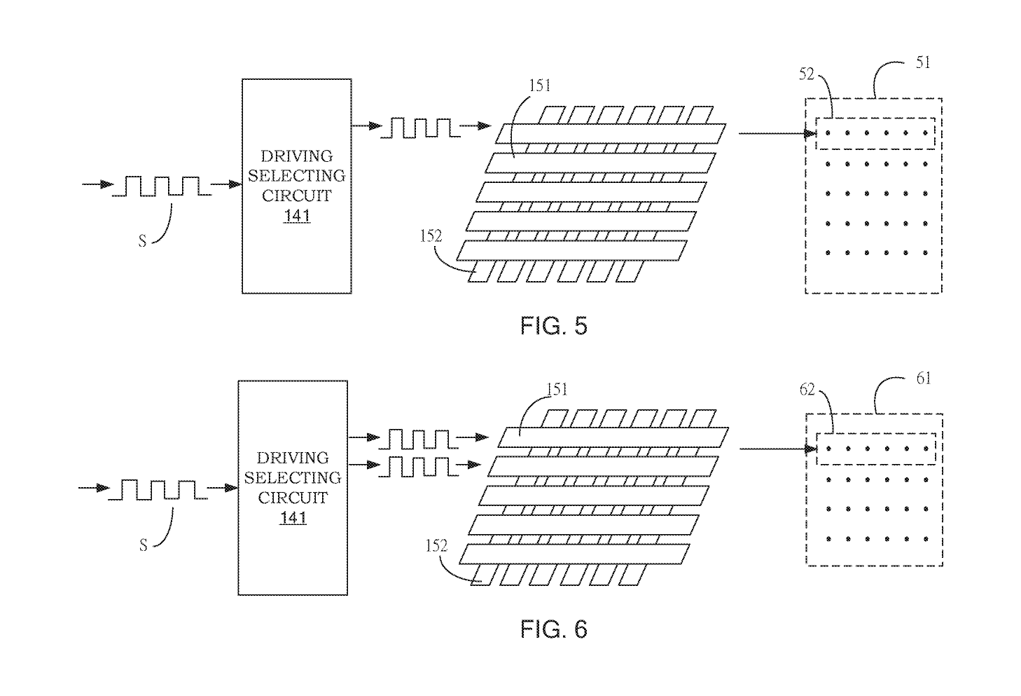

Referring to FIG. 5, a schematic diagram illustrating the single-electrode driving mode proposed by the present invention is shown. A driving signal S is sequentially provided to a first driving electrode, a second driving electrode . . . , and the last driving electrode. 1D sensing information for single-electrode driving 52 is generated when each driving electrode is driven by the driving signal S. All the 1D sensing information for single-electrode driving 52 are combined together to constitute a full image 51. Each value of the full image 51 corresponds to changes in capacitive coupling of one of the electrode intersections.

Furthermore, each value of the full image 51 corresponds to a location of one of the intersections. For example, the center location of each driving electrode corresponds to a first 1D coordinate, while the center location of each detecting electrode corresponds to a second 1D coordinate. The first 1D coordinate can be one of a lateral (e.g. horizontal or X-axis) coordinate and longitudinal (e.g. vertical or Y-axis) coordinate, while the second 1D coordinate can be the other one of a lateral (e.g. horizontal or X-axis) coordinate and longitudinal (e.g. vertical or Y-axis) coordinate. Each intersection corresponds to a 2D coordinate of a driving electrode and a detecting electrode intersecting thereat. The 2D coordinate is made up of the first 1D coordinate and the second 1D coordinate, for example, (first 1D coordinate, second 1D coordinate) or (second 1D coordinate, first 1D coordinate). In other words, the 1D sensing information generated by each single-electrode driving corresponds to the first 1D coordinate at the center of a driving electrode, wherein each value of the 1D sensing information for single-electrode driving (or each value of the full image) corresponds to a 2D coordinate made up of the first 1D coordinate at the center of the driving electrode and the second 1D coordinate at the center of a detecting electrode. Similarly, each value of the full image corresponds to the center location of one of the intersections, that is, corresponds to a 2D coordinate made up of the first 1D coordinate at the center of a driving electrode and the second 1D coordinate at the center of a detecting electrode.

Referring to FIG. 6, a schematic diagram illustrating the two-electrode driving mode proposed by the present invention is shown. A driving signal S is sequentially provided to a first pair of driving electrodes, a second pair of driving electrodes . . . , and the last pair of driving electrodes. 1D sensing information for two-electrode driving 62 is generated when each pair of driving electrodes is driven by the driving signal S. In other words, N driving electrodes make up N−1 (multiple) pairs of driving electrodes. All the 1D sensing information for two-electrode driving 62 are combined together to constitute a reduced image 61. The number of values (or pixels) of the reduced image 61 is less than the number of values (or pixels) of the full image 51. In contrast to the full image, each 1D sensing information for two-electrode driving 62 of the reduced image corresponds to a first 1D coordinate of a center location between a pair of driving electrodes, and each value corresponds to a 2D coordinate made up of the first 1D coordinate of the center location between the pair of driving electrodes and a second 1D coordinate at the center of a detecting electrode. In other words, each value of the reduced image corresponds to the location of the center between a pair of intersections, that is, corresponds to a 2D coordinate made up of the first 1D coordinate of the center location between a pair of driving electrodes (or one of several pairs of driving electrodes) and a second 1D coordinate at the center of a detecting electrode.

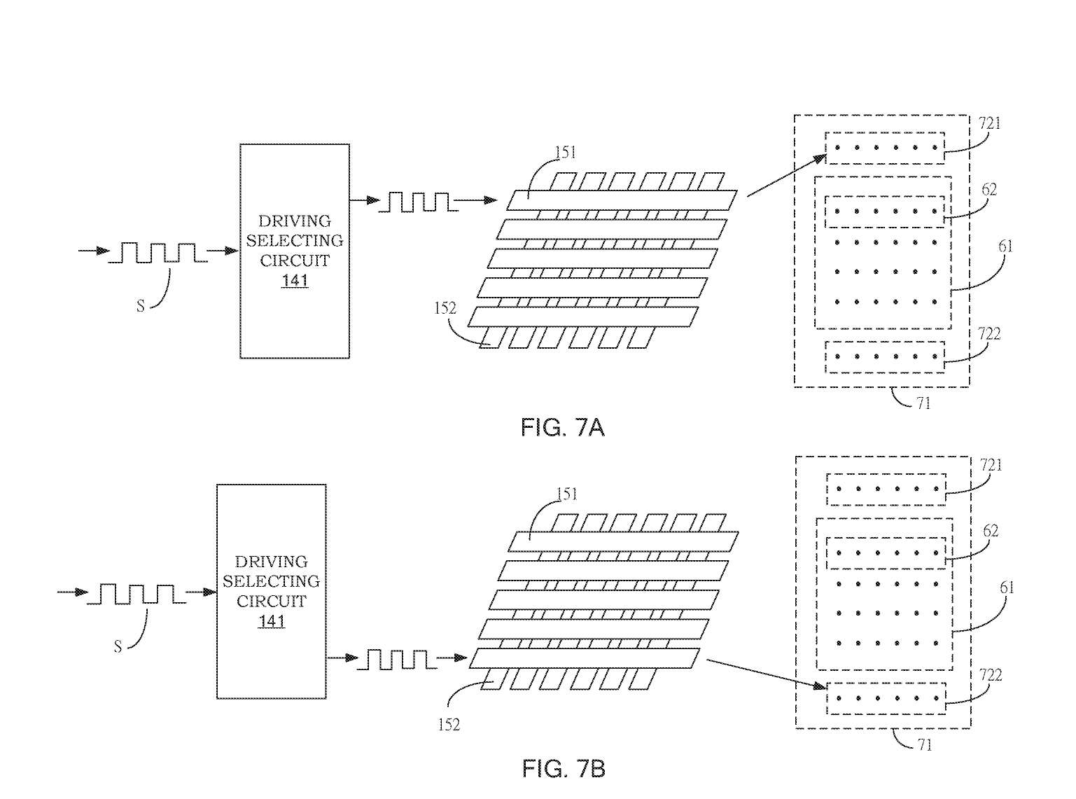

Referring to FIG. 7A, a schematic diagram illustrating a first side single-electrode driving in the two-electrode driving mode proposed by the present invention is shown. A driving signal S is provided to a driving electrode being nearest to a first side of a capacitive touch screen, and first-side 1D sensing information for single-electrode driving 721 is generated when the driving electrode being nearest to the first side of the capacitive touch screen is driven by the driving signal S. Now referring to FIG. 7B, a schematic diagram illustrating a second side single-electrode driving in the two-electrode driving mode proposed by the present invention is shown. A driving signal S is provided to a driving electrode being nearest to a second side of a capacitive touch screen, and second-side 1D sensing information for single-electrode driving 722 is generated when the driving electrode being nearest to the second side of the capacitive touch screen is driven by the driving signal S. The 1D sensing information for single-electrode driving 721 and 722 are generated when the driving electrodes being nearest to the first and second sides of the capacitive touch screen are driven, and are placed outside the first and second sides of the reduced image 61 mentioned before, respectively, to form an expanded image 71. The number of values (or pixels) in the expanded image 71 is greater than the number of values (or pixels) in the full image 51. In an example of the present invention, the first-side 1D sensing information for single-electrode driving 721 is generated first, then the reduced image 61 is generated, and then the second-side 1D sensing information for single-electrode driving 722 is generated to construct the expanded image 71. In another example of the present invention, the reduced image 61 is generated first, and thereafter, the first- and second-side 1D sensing information for single-electrode driving 721 and 722 are generated to construct the expanded image 71.

In other words, the expanded image is made up of the first-side 1D sensing information for single-electrode driving, the reduced image and the second-side 1D sensing information for single-electrode driving. Since the values in the reduced image 61 are two-electrode driven, the average magnitude will be greater than that of the first- and second-side 1D sensing information for single-electrode driving. In an example of the present invention, the values of the first- and second-side 1D sensing information for single-electrode driving 721 and 722 are first amplified by a ratio before placing outside the first and second sides of the reduced image 61. This ratio can be a predetermined multiple greater than 1, or based on the ratio between the values of the 1D sensing information for two-electrode driving and the values of the 1D sensing information for single-electrode driving, for example, the ratio between the sum (or average) of all the values of the first-side 1D sensing information for single-electrode driving 721 and the sum (or average) of all the values of the 1D sensing information 62 near the first side in the reduced image, and the values of the first-side 1D sensing information for single-electrode driving 721 are amplified by this ratio before placing outside the first side of the reduced image 61. Similarly, the ratio between the sum (or average) of all the values of the second-side 1D sensing information for single-electrode driving 722 and the sum (or average) of all the values of the 1D sensing information 62 near the second side in the reduced image, and the values of the second-side 1D sensing information for single-electrode driving 722 are amplified by this ratio before placing outside the second side of the reduced image 61. Alternatively, for example, the ratio is the ratio between the sum (or average) of all the values in the reduced image 61 and the sum (or average) of all the values of the first- and second-side 1D sensing information for single-electrode driving 721 and 722.

In the single-electrode driving mode, each value (or pixel) of the full image corresponds to a 2D location (or coordinate) of an intersection made up of the first 1D location (or coordinate) corresponding to the driving electrode and the second 1D location (or coordinate) corresponding to the detecting electrode intersecting at the intersection, for example (first 1D location, second 1D location) or (second 1D location, first 1D location). A single external conductive object may be capacitively coupled to one or more intersections. The intersection(s) capacitively coupled to the external conductive object generate(s) changes in capacitive coupling, which are reflected in the corresponding value(s) in the full image, that is, in the corresponding value(s) in the full image corresponding to the external conductive object. Thus, based on the corresponding values and 2D coordinates in the full image corresponding to the external conductive object, a centroid location (a 2D coordinate) of the external conductive object can be calculated.

In an example of the present invention, in the single-electrode driving mode, the 1D location corresponding to each electrode (driving and detecting electrodes) is the center location of the electrode. Based on another example of the present invention, in the two-electrode driving mode, the 1D location corresponding to each pair of electrodes (driving and detecting electrodes) is the center location between the two electrodes.

In the reduced image, a first 1D sensing information corresponds to the center location of a first pair of driving electrodes, that is, a first 1D location of the center between a first and a second driving electrodes (the first pair of driving electrodes). If the centroid location is simply calculated, a location can be calculated only in the range from the center of the first pair of driving electrodes to the center of the last pair of driving electrodes. The range in which the location is calculated based on the reduced image lacks a range from the center location of the first driving electrode to the center location (the first 1D location of the center) of the first pair of driving electrodes, and a range from the center location of the last pair of driving electrodes to the center location of the last driving electrode.

In contrast to the reduced image, in the expanded image, the first- and second-side 1D sensing information correspond to the center locations of the first and last driving electrodes, respectively. Thus, the range in which the location is calculated based on the expanded image, compared to that calculated based on the reduced image, further includes the range from the center location of the first driving electrode to the center location (the first 1D location of the center) of the first pair of driving electrodes, and the range from the center location of the last pair of driving electrodes to the center location of the last driving electrode. In other words, the range in which the location is calculated based on the expanded image covers the range in which the location is calculated based on the full image.

Similarly, the two-electrode driving mode can be further expanded to a multiple-electrode driving mode, that is, multiple driving electrodes are simultaneously driven. In other words, the driving signal is simultaneously provided to multiple (or all) driving electrodes in a set of driving electrodes. The number of driving electrodes in a set of driving electrodes may, for example, be two, three or four. The multiple-electrode driving mode includes the two-electrode driving mode, but not the single-electrode driving mode.

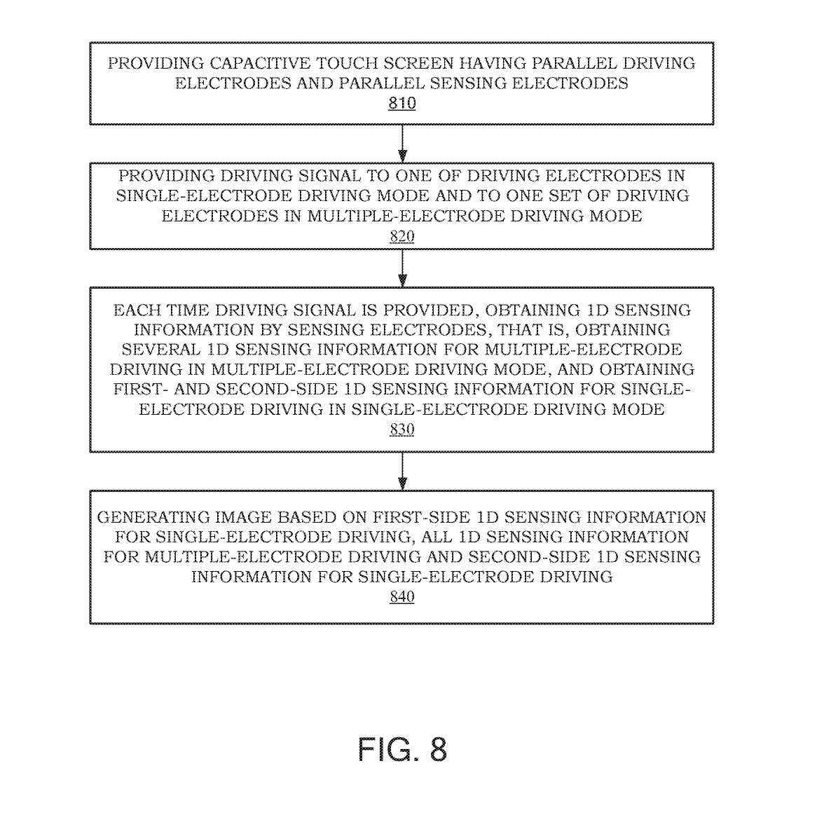

Referring to FIG. 8, a detecting method for a capacitive touch screen proposed by the present invention is shown. In step 810, a capacitive touch screen including a plurality of parallel driving electrodes and a plurality of parallel detecting electrodes is provided, wherein the driving electrodes and the detecting electrodes (e.g. the driving electrodes 151 and the detecting electrodes 152) cross each other at intersections. Next, in step 820, one and a set of driving electrodes among the plurality of driving electrodes is/are provided with a driving signal in the single-electrode driving mode and the multiple-electrode driving mode, respectively, that is, one of the driving electrodes is driven by the driving signal at a time in the single-electrode driving mode, while a set of driving electrodes in the driving electrodes are simultaneously driven by the driving signal at a time in the multiple-electrode driving mode, wherein apart from the last N driving electrodes, each driving electrodes and two successive driving electrodes form the set of driving electrodes to be driven simultaneously, and N is the number of the set minus one. The driving signal can be provided by the driving circuit 41 described before. Thereafter, in step 830, each time the driving signal is provided, 1D sensing information is obtained via the detecting electrodes; more specifically, a plurality of 1D sensing information for multiple-electrode driving are obtained in the multiple-electrode driving mode and first- and second-side 1D sensing information for single-electrode driving are obtained in the single-electrode driving mode. For example, in the multiple-electrode driving mode, one 1D sensing information for multiple-electrode driving is obtained when each set of driving electrodes are provided with the driving signal. Alternatively, for example, in the single-electrode driving mode, one first-side 1D sensing information for single-electrode driving and one second-side 1D sensing information for single-electrode driving are obtained when the first driving electrode and the last driving electrode are provided with the driving signal, respectively. The 1D sensing information can be obtained by the detecting circuit 42 described above. The 1D sensing information thus includes the 1D sensing information for multiple-electrode driving (reduced image) and the first- and second-side 1D sensing information for single-electrode driving. Then, in step 840, an image (an expanded image) is generated according to the first-side 1D sensing information for single-electrode driving, all the 1D sensing information for multiple-electrode driving and the second-side 1D sensing information for single-electrode driving. Step 840 can be performed by the control circuit described before.

As described before, the potential of the driving signal in the single-electrode driving mode is not necessary the same as the potential of the driving signal in the multiple-electrode driving mode; they can be the same or different. For example, the single-electrode driving is performed with a first AC potential larger than a second AC potential for the multiple-electrode driving. The ratio of the first AC potential to the second AC potential can be a predetermined ratio. In addition, in step 840, the image is generated based on all the values of the first- and second-side 1D sensing information for single-electrode driving being multiplied by the same predetermined ratio or different predetermined ratios. Moreover, the frequency of the driving signal in the single-electrode driving mode can be different from that of the driving signal in the multiple-electrode driving mode.

The number of driving electrodes in the set of driving electrodes can be two, three or more; the present invention is not limited to these. In a preferred mode of the present invention, the number of driving electrodes in the set of driving electrodes is two. When the number of driving electrodes in the set of driving electrodes is two, each driving electrode corresponds to a first 1D coordinate, wherein 1D sensing information driven by each group (or pair) of the electrodes corresponds to a first 1D coordinate of the center between the pair of driving electrodes among the plurality of driving electrodes, and the first- and second-side 1D sensing information for single-electrode driving correspond to first 1D coordinates of the first and the last driving electrodes, respectively.

Similarly, when the number of driving electrodes in the set of driving electrodes is more than two, each driving electrode corresponds to a first 1D coordinate, wherein 1D sensing information driven by each set of multiple electrodes corresponds to a first 1D coordinate of the center between two driving electrode separated the furthest in the set of driving electrodes, and the first- and second-side 1D sensing information for single-electrode driving correspond to first 1D coordinates of the first and the last driving electrodes, respectively.

Moreover, each detecting electrode corresponds to a second 1D coordinate, and each value of each 1D sensing information corresponds to the second 1D coordinate of one of the detecting electrodes.

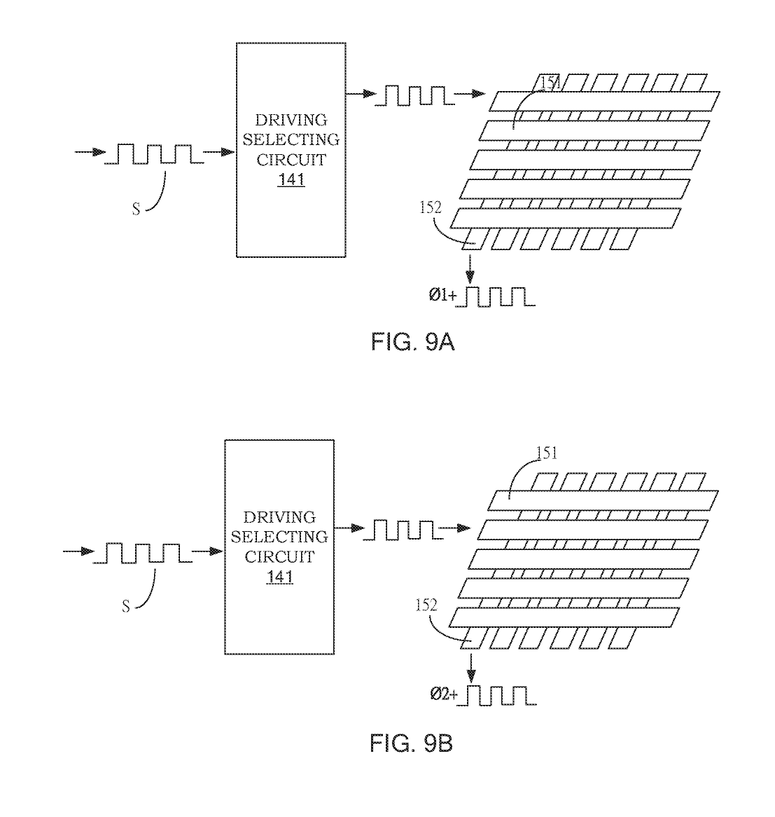

Referring to FIGS. 9A and 9B, two schematic diagrams illustrating the detecting electrodes receiving capacitively coupled signals via driving electrodes are shown. Since signals pass through electrical loads, such as capacitive coupling, the signals received by the detecting electrodes and the signals before being provided to the driving electrodes generate phase difference. For example, the first phase difference φ1 is generated between the signal received by the first detecting electrode and the signal before being provided to the driving electrode, as shown in 9A. When the driving signal is provided to the second driving electrode, the second phase difference φ2 is generated between the signal received by the first detecting electrode and the signal before being provided to the driving electrode, as shown in 9B. In one embodiment of the present invention, the phase difference could signify the time of the signal passing through the load, and could also represent the time difference between the capacitively coupled signal received by the detecting electrode via the driving electrode and the signal sent by the driving electrode. Since the position of each driving electrode is different, the phase differences for the same one detecting electrode to different driving electrodes are different.

The first phase difference φ1 and the second phase difference φ2 are different due to different RC circuits through which the driving signals pass. When the periods of the driving signals are the same, different phase differences represent that signals with different time delays are received. If avoiding the foregoing phase difference to detect signals directly, the measurement results will be different due to the different initial phases of the signals. For example, the phase difference is 0 degree, and the signal is a sinusoidal wave with the amplitude A. When detecting the signals with the phase differences of 30 degrees, 90 degrees, 150 degrees, 210 degrees, 270 degrees and 330 degrees, the signals of |1/2A|, |A|, |1/2A|, |−1/2A|, |−A| and |−1/2A| will be received, respectively. But at the phase difference of 150 degrees, the phase differences are measured with deviation so as to receive the signals of

$$0 , - \frac{\sqrt{2}}{2} A , - \frac{\sqrt{2}}{2} A , 0 , \frac{\sqrt{2}}{2} A and \frac{\sqrt{2}}{2} A$$

when detecting the signals with the phase differences of 180 degrees, 240 degrees, 300 degrees, 360 degrees, 420 degrees and 480 degrees.

In the above-mentioned embodiment, initial phase delay of the measurement due to the phase difference causes the different measurement result. Whether the driving signal is the sinusoidal wave or the square wave, such as PWM, the similar difference always exists.

In addition, when the driving signal is provided each time, it can be provided to a plurality of adjacent driving electrodes, wherein the driving electrodes are parallelized arranged in order. In the preferred embodiment of the invention, the driving signal is provided to two adjacent driving electrodes. At one scan, n driving electrodes are provided the driving signal n−1 times, wherein the driving signal is provided to one set of the driving electrodes. For example, the first and second driving electrodes are provided at first time, the second and third driving electrodes are provided at second time, and so on. As above-mentioned, when the driving signal is provided each time, the provided set of driving electrodes could be one, two or more driving electrodes. The amount of the driving electrodes being provided the driving signal is not limited in the invention. When the driving signal is provided each time, all signals measured by the detecting electrodes could compose a 1-D sensing information. All 1-D sensing information at one scan could compose a 2-D sensing information which could be considered to an image.

Accordingly, in the best mode of a first embodiment of the invention, different phase differences are adopted at different electrodes so as to delay the detecting signal. For example, a plurality of phase differences are decided at first. When each set of driving electrodes are provided the driving signal, the signal is measured based on each phase difference. The phase difference on which the largest one of the measured signals stands closest approaches the phase difference between the signal before being provided to the driving electrodes and the signal after being received by the detecting electrodes, called the closest phase difference. The signal measurement could be to select one of the detecting electrodes to measure based on each phase difference, or select many or all detecting electrodes to measure based on each phase difference. The closest phase difference is determined based on the total amount of signals of the many or all detecting electrodes. Accordingly, the closest phase difference of each set of electrodes could be determined. In other words, after each set of electrodes are provided the driving signal, the closest phase difference of all the detecting delayed to be provided the driving signal starts to be measured.

In addition, the signals could be measured based on part of the phase differences rather than all of them. The signals could be measured based on one of the phase differences in order, and be stopped until measuring the gradually increasing signal followed by the gradually decreasing signal, wherein the largest one of the measured signals is measured based on the closest phase difference. In this way, the image with stronger signals could be obtained.

In addition, a set of the driving electrodes could be selected to be a base electrode firstly, and others of the electrodes are called the non-base electrodes. At first, the closest phase difference of the base electrode is detected to be as a level phase difference. Then the difference of the closest level phase differences of the non-base electrodes are detected to be as a most level phase difference. For example, the signal which is measured based on the level phase difference of the base electrode is used as a level signal. Then, the signal is gotten by measuring each phase difference of each set of the non-base driving electrode. The phase difference of the signal which is the closest one to the level signal is used as the level phase difference of the driving electrode which provides the driver signal. Thus, the level phase difference of each set of driving electrodes could be determined, and more level image could be obtained by delaying the following signal measurement based on the level phase differences of each set of driving electrodes, e.g. differences among signals in the image are very small. In addition, the level signal could be in a preset working range rather than a best or largest signal.

In the above-mentioned embodiment, when the driving signal is provided each time, all detecting electrodes are adopted the same phase difference. It can be appreciated by one with ordinary skill in the art that each set of detecting electrodes is separately adopted corresponding the closest phase difference or level phase difference when the driving signal is provided each time. In other words, when the driving signal is provided each time, signal measurement of each phase difference of each set of detecting electrodes is executed so as to determine the closest phase difference or the level phase difference.

Actually, the larger or the more level image could be obtained based on different amplification factors, impedances or measurement times except for delaying measurement by phase differences.

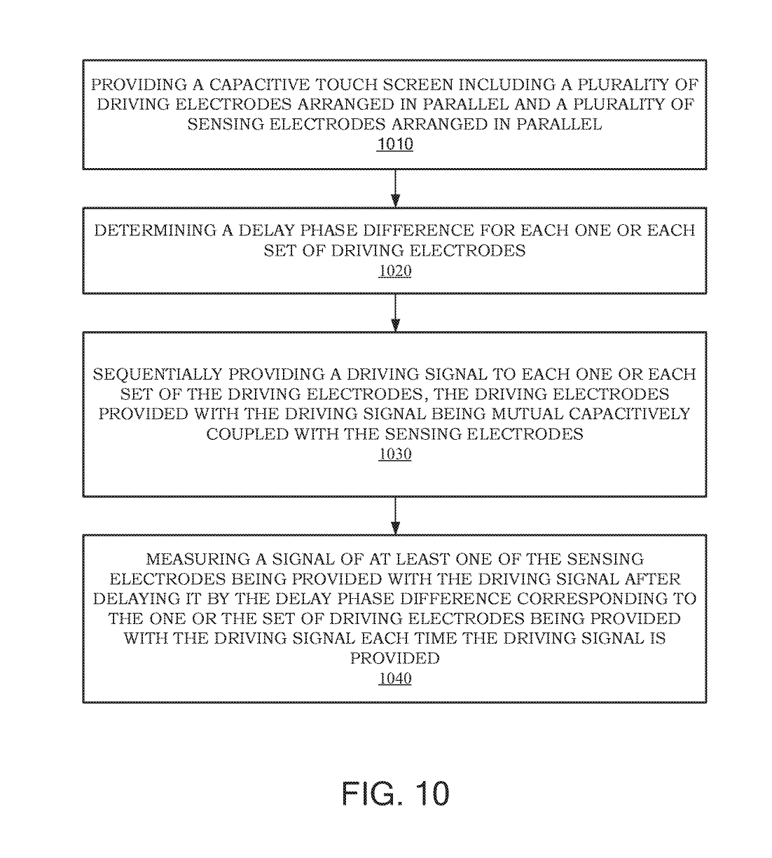

Accordingly, the invention discloses a signal detecting method for touch screen, as shown in FIG. 10. In step 1010, a touch screen including a plurality of parallel driving electrodes and a plurality of parallel detecting electrodes is provided, wherein the driving electrodes and the detecting electrodes cross each other at multiple intersections. In addition, in step 1020, a delay phase difference of each driving electrode or each set of driving electrodes is determined. Then, in step 1030, one or a set of driving electrode(s) among the plurality of driving electrodes is(are) provided with a driving signal in order, and the detecting electrodes are mutually capacitively coupled to the driving electrodes which the driving signal is provided to. Next, in step 1040, when the driving signal is provided each time, signals of each detecting combination which the driving signal is provided to is measured after delaying the corresponding phase difference.

Accordingly, in the signal detecting device for touch screen of the invention, the above-mentioned step 1030 could be executed by the driving circuit 41. In addition, the step 1040 could be executed by the detecting circuit 42.

In one embodiment of the invention, the delay phase difference of each driving electrode or each set of driving electrodes is selected from preset phase differences, e.g. the closest phase difference is selected. Each set of electrodes means one set of a plurality of electrodes which are provided the driving signal simultaneously when a plurality of electrodes are driven, e.g. it is executed by the driving selecting circuit 141 of the driving circuit 41. For example, one or one set of the driving electrode(s) is(are) selected as the selected electrode in order, e.g. it is executed by the driving circuit 41. Next, the delay phase difference of the selected electrode is selected from a plurality of preset phase differences, wherein when the driving signal is provided to the selected electrode, the signal which is measured after delaying the delay phase difference is larger than the signal which is measured after delaying other preset phase difference. For example, it is executed by the detecting circuit 42, and the detected delay phase difference could be stored in the storage circuit 43.

Furthermore, the level phase difference could be selected. For example, one driving electrode or one set of electrodes is selected as the base electrode, and other electrodes or other sets of electrodes are as non-base electrode, e.g. it is executed by the driving circuit 41. Next, the delay phase difference of the base electrode is selected from a plurality of preset phase differences. When the driving signal is provided to the base electrode, signals detected after delaying the delay phase difference are larger than signals detected after delaying other preset phase differences. The delay phase difference for the base electrode is the level phase difference. The signal detected at the base electrode after delaying the delaying phase difference is as the base signal. Then, one non-base electrode or one set of non-base electrodes is(are) selected as selected electrode in order, and the delay phase difference of the selected electrode is selected from the a plurality of preset phase differences, e.g. the most level phase difference, wherein when the driving signal is provided to the selected electrode, signals measured after delaying the delay phase difference are closest to the level signal than signals measured after delaying other preset phase differences. The above-mentioned embodiment could be executed by the detecting circuit 42.

In one embodiment of the invention, when the driving signal is provided to the base electrode or the selected electrode, signals measured from plurality of the detecting electrodes are the signals measured from one of the detecting electrodes. In other words, the delay phase difference is selected from the signal of the identical detecting electrode. In another embodiment of the invention, when the driving signal is provided to the base electrode or the selected electrode, signals measured from plurality of the detecting electrodes are sum of the signals measured from at least two detecting electrodes. In other words, the delay phase difference is selected from the signals of the identical plurality or all of the detecting electrodes.

As above-mentioned, each intersection could be corresponding to a delay phase difference, wherein each one or each sets of driving electrodes and the detecting electrodes cross each other at intersections. Thereinafter, it is a detecting combination that each one or each sets of driving electrodes separately cross each one or each sets of detecting electrodes. In other words, the driving signal could be provided to one or a plurality of driving electrodes simultaneously, and signals could be measured by one or a plurality of detecting electrodes. When a signal is produced by measurement, one or a plurality of driving electrodes being provided the driving signal and one or a plurality of detecting electrodes being measured are called as a detecting combination. For example, when single electrode or a plurality of electrodes are driven, a signal value is measured by one electrode; a differential value is measured by two electrodes; or a dual differential value is measured by three electrodes. The differential value is the difference between signals of two adjacent electrodes, and the dual differential value is the difference between the difference of the former two of three adjacent electrodes and the difference of the latter two of three adjacent electrodes.

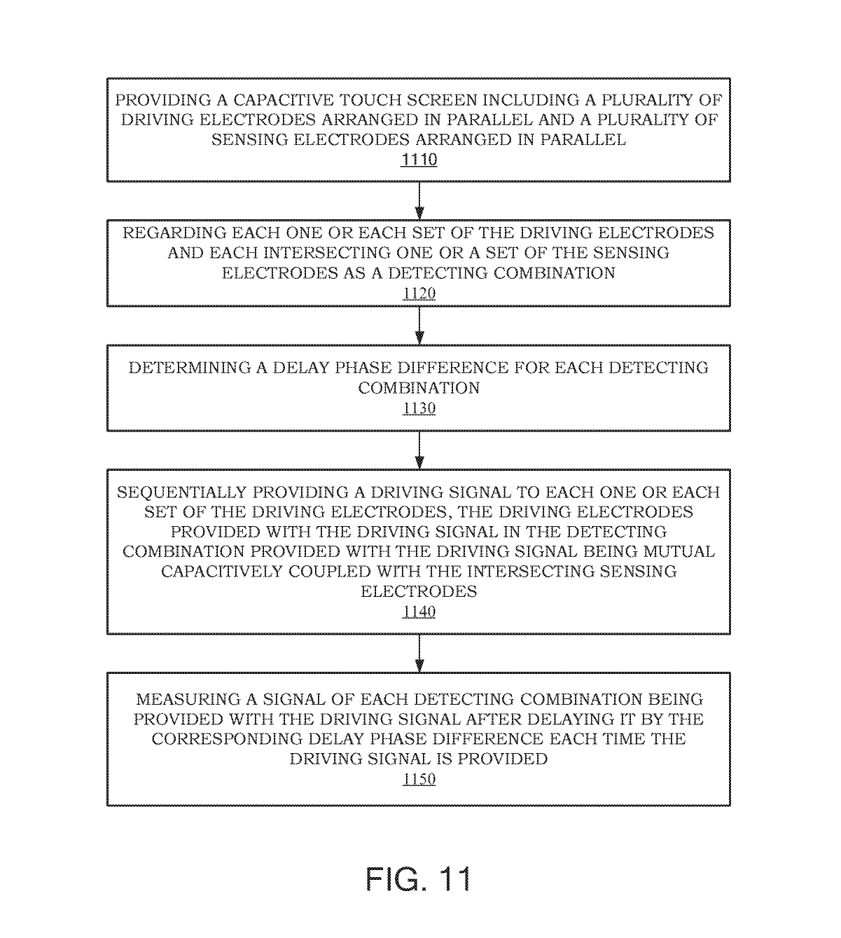

Accordingly, another embodiment of the invention is a signal detecting method for touch screen, shown as FIG. 11. In step 1110, a touch screen is provided, wherein the touch screen includes a plurality of parallel driving electrodes and a plurality of parallel detecting electrodes, and the driving electrodes and the detecting electrodes cross each other at intersections. Furthermore, in step 1120, it is a detecting combination that each one or each sets of driving electrodes separately cross each one or each sets of detecting electrodes. In step 1130, a delay phase difference of a detecting combination is determined. Then, in step 1140, one or one set of driving electrodes are provided a driving signal in order, wherein the driving electrode, which is provided the driving signal, in the detecting combination is mutually capacitively coupled to the detecting electrodes which cross the driving electrode, Next, in step 1150, when the driving signal is provided each time, signals of each detecting combination which is provided driving signal is measured after delaying the corresponding phase difference.

Accordingly, in the signal detecting device of the invention, the step 1140 could be executed by the driving circuit 41, and the step 1150 could be executed by the detecting circuit 42.

In one embodiment of the invention, the step 1130 could include: one of the detecting combinations could be selected in order to be as the selected detecting combination, which could be executed by the driving circuit 41; and the delay phase difference of the selected detecting combination is selected from a plurality of preset phase difference, wherein when the driving signal is provided to the selected detecting combination, the signal which is measured after delaying the delay phase difference is larger than the signal which is measured after delaying other preset phase difference, which could be executed by the detecting circuit 42.

In another embodiment of the invention, the delay phase difference of each detecting combination could be further determined by the following specifications. One of the detecting combinations is selected as a base detecting combination, other detecting combinations are as non-base detecting combinations, and one of the non-base detecting combinations are selected in order as the selected detecting combination, which are executed by the driving circuit 41. In addition, the delay phase difference of base detecting combination is selected from the a plurality of preset phase differences, wherein when the driving signal is provided to the base detecting combination, signals detected after delaying the delay phase difference are larger than signals detected after delaying other preset phase differences, and signals detected after the delay phase difference delayed by the base detecting combination is as a base signal. Further, the delay phase difference of selected detecting combination is selected from the plurality of preset phase differences, wherein when the driving signal is provided to the selected detecting combination, signals measured after delaying the delay phase difference are closest to the level signal than signals measured after delaying other preset phase differences. The above-mentioned embodiment could be executed by the detecting circuit 42.

In a first embodiment of the present invention, the delay phase difference can be carried out by many delaying circuits. For example, it can be performed by selecting one of fixed delaying lines or using programmable digital delaying components or delaying some clock signals. It can be appreciated by one with ordinary skill in the art that there are many ways to implement the delay phase difference, and the present invention is not limited to.

In a second embodiment of the invention, signals are measured by a control circuit, and signals of each set of detecting electrodes are measured via a variable resistor, respectively, wherein the impedance of the variable resistor is controlled by the control circuit based on each set of driving electrodes. For example, one set of the driving electrodes could be selected as the base electrodes firstly, and others of the electrodes are called the non-base electrodes. At first, a plurality of preset impedances are set, and when one or more base electrodes are provided the driving signal, signals of one detecting electrode are measured, or sum of the plurality or all of detecting electrodes are measured as a level signal. In addition, the level signal could be within a preset working range rather than the best or largest signal. In other words, any preset impedance which can make the level signal within the preset working range could be the level impedance of the base electrode. Next, when each set of the non-base electrodes are provided the driving signal, the variable resistor is adjusted based on each preset impedance. The signal of the detecting electrode is measured or sum of the plurality or all of detecting electrodes are measured so as to find out the preset impedance which is closest to the level signal, and the preset impedance is as the level impedance corresponding to the set of the non-base electrode which is provided the driving signal. Thus, the level impedance of each set of the driving electrodes could be determined, and the impedance of the variable resistor could be adjusted based on the level impedance of each set of the driving electrodes (the variable resistor is adjusted to the level impedance) so as to obtain the more level image, i.e. differences among signals of the image are small.

In the above-mentioned description, when the driving signal is provided each time, all detecting electrodes are used the same level impedance. It can be appreciated by one with ordinary skill in the art that when the driving signal is provided each time, each set of the detecting electrodes are used separately the corresponding level impedances. In other words, when the driving signal is provided each time, signal is measured by separately detecting each preset impedance of each set of detecting electrodes so as to determine the preset impedance which is closest to the level signal. Accordingly, when the driving signal is provided to each set of the driving electrodes, the level impedance of each detecting electrode is separately obtained so as to adjust the impedance of the variable resistor which is electrically coupled to each detecting electrode.

The control circuit could consist of one or more ICs except electrical elements. In one embodiment of the invention, the variable resistor could be built in the IC, and the impedance of the variable resistor is control by the programmable program (e.g. firmware in the IC). For example, the variable resistor consists of a plurality of resistors and is controlled by a plurality of switches. The impedance of the variable resistor is adjusted by on and off of different switches. Since the variable resistors and such program are well-known in the art, they will not be further described herein. The program for controlling the variable resistors in the IC chip can be altered through firmware modifications in order to accommodate touch panels with different characteristics, thereby effectively reducing cost and achieving commercial mass production.

In a third embodiment of the invention, signals are measured by a control circuit. Signals of each set of detecting electrodes are measured via a detecting circuit (e.g. an integrator), respectively, and the control circuit controls the amplification factor of the detecting circuit based on each set of driving electrodes, such as controlling the amplification factor of the amplifying circuit 17 as shown in FIGS. 1 and 4. For example, one set of the driving electrodes are selected as the base electrode, and other electrodes are called as non-base electrodes. At first, a plurality of preset amplification factors are set, and when one or more base electrodes are provided the driving signal, signals of one detecting electrode are measured, or sum of the plurality or all of detecting electrodes are measured as a level signal. In addition, the level signal could be within a preset working range rather than the best or largest signal. In other words, any preset amplification factor which can make the level signal within the preset working range could be the level amplification factor of the base electrode. Next, when each set of the non-base electrodes are provided the driving signal, the detecting circuit is adjusted based on each preset amplification factor. The signal of the detecting electrode is measured or sum of the plurality or all of detecting electrodes are measured so as to find out the preset amplification factor which is closest to the level signal, and the preset amplification factor is as the level amplification factor corresponding to the set of the non-base electrode which is provided the driving signal. Thus, the level amplification factor of each set of the driving electrodes could be determined, and the amplification factor of the detecting circuit could be adjusted based on the level amplification factor of each set of the driving electrodes so as to obtain the more level image, i.e. differences among signals of the image are small.

In the above-mentioned description, when the driving signal is provided each time, all detecting electrodes are used the same level amplification factor. It can be appreciated by one with ordinary skill in the art that when the driving signal is provided each time, each set of the detecting electrodes are used separately the corresponding level amplification factors. In other words, when the driving signal is provided each time, signal is measured by separately detecting each preset amplification factor of each set of detecting electrodes so as to determine the preset amplification factor which is closest to the level signal. Accordingly, when the driving signal is provided to each set of the driving electrodes, the level amplification factor of each detecting electrode is separately obtained.

In a forth embodiment of the invention, signals are measured by a control circuit. Signals of each set of detecting electrodes are measured via a detecting circuit (e.g. an integrator), respectively, and the control circuit controls the measurement time of the detecting circuit based on each set of driving electrodes. For example, one set of the driving electrodes are selected as the base electrode, and other electrodes are called as non-base electrodes. At first, a plurality of preset measurement times are set, and when one or more base electrodes are provided the driving signal, signals of one detecting electrode are measured, or sum of the plurality or all of detecting electrodes are measured as a level signal. In addition, the level signal could be within a preset working range rather than the best or largest signal. In other words, any preset measurement time which can make the level signal within the preset working range could be the level measurement time of the base electrode. Next, when each set of the non-base electrodes are provided the driving signal, the detecting circuit is adjusted based on each preset measurement time. The signal of the detecting electrode is measured or sum of the plurality or all of detecting electrodes are measured so as to find out the preset measurement time which is closest to the level signal, and the preset measurement time is as the level measurement time corresponding to the set of the non-base electrode which is provided the driving signal. Thus, the level measurement time of each set of the driving electrodes could be determined, and the measurement time of the detecting circuit could be adjusted based on the level measurement time of each set of the driving electrodes so as to obtain the more level image, i.e. differences among signals of the image are small.

In the above-mentioned description, when the driving signal is provided each time, all detecting electrodes are used the same level measurement time. It can be appreciated by one with ordinary skill in the art that when the driving signal is provided each time, each set of the detecting electrodes are used separately the corresponding level measurement times. In other words, when the driving signal is provided each time, signal is measured by separately detecting each preset measurement time of each set of detecting electrodes so as to determine the preset measurement time which is closest to the level signal. Accordingly, when the driving signal is provided to each set of the driving electrodes, the level measurement time of each detecting electrode is separately obtained.

In a fifth embodiment of the invention, the control signal controls the duration of driving time (the period of driving time or the length of driving time) of each set of driving electrodes (driving strips) being provided the driving signal based on each set of driving electrodes. For example, one set of the driving electrodes is selected as the base electrode, and other electrodes are called as non-base electrodes. At first, a plurality of preset driving time periods are set, and when one or more base electrodes are provided the driving signal until reaching a certain preset driving time period, signals of one detecting electrode (sensing strip) are measured, or sum of the plurality or all of detecting electrodes are measured as a level signal. In addition, the level signal could be within a preset working range rather than the best or largest signal. In other words, any preset driving time period which can make the level signal within the preset working range could be the preset driving time period of the base electrode. Next, when each set of the non-base electrodes are provided the driving signal, the driving circuit is adjusted based on each preset driving time period. The signal of the detecting electrode is measured or sum of the plurality or all of detecting electrodes are measured so as to find out the preset driving time period which is closest to the level signal, and the preset driving time period is as the level driving time period corresponding to the set of the non-base electrode. Thus, the level driving time period of each set of the driving electrodes could be determined, and the driving time period of the driving circuit could be adjusted based on the level driving time period of each set of the driving electrodes so as to obtain the more level image, i.e. differences among signals of the image are small.

In the above-mentioned description, when the driving signal is provided each time, all driving electrodes are used the same level driving time period. It can be appreciated by one with ordinary skill in the art that when the driving signal is provided each time, each set of the driving electrodes are used separately the corresponding level driving time periods. In other words, when the driving signal is provided each time, driving signal reaching a certain driving time period is respectively provided to each set of driving electrode so as to determine the preset driving time period which is closest to the level signal. Accordingly, when the driving signal is provided to each set of the driving electrodes, the level driving time period of each driving electrode is separately obtained.

In a sixth embodiment of the invention, the control signal controls the driving potential of each set of driving electrodes (driving strips) being provided the driving signal based on each set of driving electrodes. For example, one set of the driving electrodes is selected as the base electrode, and other electrodes are called as non-base electrodes. At first, a plurality of preset driving potentials are set, and when one or more base electrodes are provided the driving signal on a certain preset driving potential, signals of one detecting electrode (sensing strip) are measured, or sum of the plurality or all of detecting electrodes are measured as a level signal. In addition, the level signal could be within a preset working range rather than the best or largest signal. In other words, any preset driving potential which can make the level signal within the preset working range could be the preset driving potential of the base electrode. Next, when each set of the non-base electrodes are provided the driving signal, the driving circuit is adjusted based on each preset driving potential. The signal of the detecting electrode is measured or sum of the plurality or all of detecting electrodes are measured so as to find out the preset driving potential which is closest to the level signal, and the preset driving potential is as the level driving potential corresponding to the set of the non-base electrode. Thus, the level driving potential of each set of the driving electrodes could be determined, and the driving potential of the driving circuit could be adjusted based on the level driving potential of each set of the driving electrodes so as to obtain the more level image, i.e. differences among signals of the image are small.

In the above-mentioned description, when the driving signal is provided each time, all driving electrodes are used the same level driving potential. It can be appreciated by one with ordinary skill in the art that when the driving signal is provided each time, each set of the driving electrodes are used separately the corresponding level driving potentials. In other words, when the driving signal is provided each time, driving potential is respectively provided to each set of driving electrode so as to determine the preset driving potential which is closest to the level signal. Accordingly, when the driving signal is provided to each set of the driving electrodes, the level driving potential of each driving electrode is separately obtained.

In a seventh embodiment of the invention, the driving time point for providing the driving signal to each set of driving electrodes (driving strips) can be decided according to each set of driving electrodes. For example, one set of the driving electrodes is selected as the base electrode, and other electrodes are called as non-base electrodes. At first, a plurality of preset driving time points are set, and when one or more base electrodes are provided the driving signal on a certain preset driving time point, signals of one detecting electrode (sensing strip) are measured, or sum of the plurality or all of detecting electrodes are measured as a level signal. In addition, the level signal could be within a preset working range rather than the best or largest signal. In other words, any preset driving time point which can make the level signal within the preset working range could be the preset driving time point of the base electrode. Next, when each set of the non-base electrodes are provided the driving signal, the time point for the driving circuit to provide the driving signal is adjusted based on each preset driving time point, respectively. The signal of the detecting electrode is measured or sum of the plurality or all of detecting electrodes are measured so as to find out the preset driving time point which is closest to the level signal, and the preset driving time point is as the level driving time point corresponding to the set of the non-base electrode. Thus, the driving time point of each set of the driving electrodes could be determined. Driving based on the driving time point of each set of the driving electrodes, the more level image, i.e. differences among signals of the image are small, can be obtained.

In the above-mentioned description, when the driving signal is provided each time, all driving electrodes are used the same driving time point. It can be appreciated by one with ordinary skill in the art that when the driving signal is provided each time, each set of the driving electrodes are used separately the corresponding level driving time points. In other words, when the driving signal is provided each time, driving signal is respectively provided to each set of driving electrode on the driving time point so as to determine the preset driving time point which is closest to the level signal. Accordingly, when the driving signal is provided to each set of the driving electrodes, the driving time point of each driving electrode is separately obtained.

It can be appreciated by one with ordinary skill in the art that the effect on changing the driving time point in the seventh embodiment is equal to that on adjusting the delay phase difference of the detecting (sensing) circuit in the first embodiment. Both of them are respectively from the respect of the driving and detecting circuits to react to the time of signals transmitted on the driving and detecting electrodes. Thus, the intensity of received signal can be strengthened or weakened by adjusting the delay phase difference of the detecting circuit or the driving time point of the driving circuit.

In the above-mentioned specification, one or any mixture of the first, second, third, fourth, fifth, sixth and seventh embodiments could be executed, the present invention is not limited as such. In addition, when measuring the level signal, the level signal could be produced by measuring one or more detecting electrodes which are farthest from the detecting electrode. For example, the level signal could be produced by measuring the electrode which is farthest from the detecting electrode, or the level signal (differential value) could be produced by measuring the differential signal between two electrodes which are farthest from the detecting electrode, or the level signal (dual differential value) could be produced by measuring the difference between the difference of the former two of three electrodes which are farthest from the detecting electrode and the difference of the latter two of three electrodes which are farthest from the detecting electrode. In other words, the level signal could be the signal value, the differential value or the dual differential value, or could be the value produced based on signals of one or more detecting electrodes.

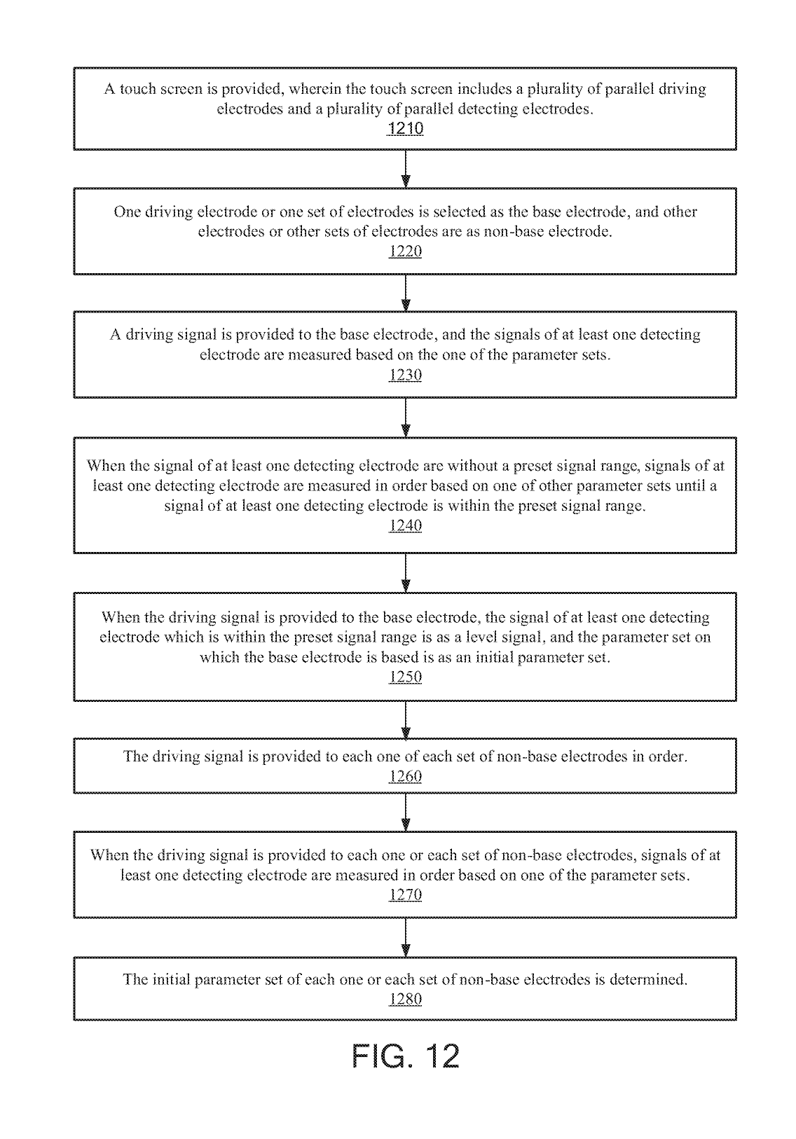

Please refer to FIG. 12, a signal detecting method for touch screen is disclosed. In step 1210, a touch screen is provided, wherein the touch screen includes a plurality of parallel driving electrodes and a plurality of parallel detecting electrodes, and the driving electrodes and the detecting electrodes cross each other at intersections. In step 1220, one driving electrode or one set of driving electrodes is selected as the base electrode, and other electrodes or other sets of electrodes are as non-base electrodes. The base electrode could be the electrode or the set of driving electrodes at the first position (intersection) or the driving electrode at any other position (intersection), the present invention is not limited as such. Then, in step 1230, a driving signal is provided to the base electrode, and the signals of at least one detecting electrode are measured based on the one of the parameter sets. In step 1240, when the signal of at least one detecting electrode are without a preset signal range, signals of at least one detecting electrode are measured in order based on one of other parameter sets until a signal of at least one detecting electrode is within the preset signal range. In addition, in step 1250, when the driving signal is provided to the base electrode, the signal of at least one detecting electrode which is within the preset signal range is as a level signal, and the parameter set on which the base electrode is based is as an initial parameter set. Then, in step 1260, the driving signal is provided to each one or each set of non-base electrodes in order, and in step 1270, when the driving signal is provided to each one or each set of non-base electrodes, signals of at least one detecting electrode are measured in order based on one of the parameter sets. Next, in step 1280, the initial parameter set of each one or each set of non-base electrodes is determined, wherein the driving signal is provided separately to each one or each set of non-base electrodes, and the signal of at least one detecting electrode detected based on the initial parameter set is the closest level signal than the signals of at least one detecting electrode detected based on other parameter sets.

According to the first, second, third, fourth, fifth, sixth and seventh embodiments, the parameter sets could be used to change the delay phase difference, the impedance (resistance value) of the variable resistor, the amplification factor (gain) of the detecting (sensing) circuit, the measurement time (duration of sensing time) of the detecting circuit, the driving time period (duration of driving time) of the driving circuit, the driving potential of the driving circuit and the driving time point of the driving circuit. In a first example of the invention, the detecting circuit connects at least one detecting electrode via a variable resistor, wherein the impedance of the variable resistor is changed based on the initial parameters of the electrodes being provided the driving signal. In a second example of the invention, the duration of detecting signal is changed based on the initial parameters of the electrodes being provided the driving signal. In a third example of the invention, the signal of at least one detecting electrode is provided to the detecting circuit after passing through an amplifier, wherein the amplification factor of the amplifier is changed based on the initial parameters of the electrodes being provided the driving signal. In addition, in a fourth example of the invention, the signal of at least one detecting signal is started to be measured after a delay phase difference, wherein the delay phase difference is changed based on the initial parameters of the electrode being provided the driving signal. In a fifth example of the invention, the driving time period is changed based on the initial parameters of the electrode being provided the driving signal. In a sixth example of the invention, the driving potential is changed based on the initial parameters of the electrode being provided the driving signal. In a seventh example of the invention, the driving time point is changed based on the initial parameters of the electrode being provided the driving signal.

Accordingly, please refer to FIG. 4, the signal measurement for a touch screen based on this invention includes a touch screen, a driving circuit 41, a detecting circuit 42, and a controlling circuit 45. The electrodes in the touch screen consist of several parallel arranged driving electrodes 151 and several parallel arranged detecting electrodes 152, and these two kinds of electrodes intersect in several cross-stack area. The driving circuit 41 provides a driving signal to one or one set of driving electrode 151 which is used as base electrode, and the others are non-base electrodes. When the driving signal is provided to the detecting circuit 42 every time, an evaluated signal for the driving electrode 151 being provided the driving signal is produced from the signal of at least one detecting electrode 152 based on one of several parameter sets. The controlling circuit 45 selects one of the parameter sets as initial parameter set of base electrode. The evaluated signal produced by the detecting circuit based on the initial parameter set is used as a level signal. The initial parameter set of every one or every set of the non-base electrode is respectively selected from the parameter sets, and the evaluated signal of every one or every set of the non-base electrode based on the initial parameter set is the closet one to the level signal comparing to other evaluated signals produced by other parameter sets. Additionally, the parameter sets can be stored in the storing circuit 43.

The evaluated signal can be produced according to the signal of one or more detecting electrode. For instance, the evaluated signal is produced by one of the detecting electrodes. Another example is that the evaluated signal is produced by the sum of the signals of at least two of the detecting electrodes.

In addition, in one example of the invention, the control circuit controls the detecting circuit to produce the evaluated signal of the base electrode based on one of the parameter sets in order. The parameter set producing the largest evaluated signal of base electrode is designated as the initial parameter set of the base electrode. In another example of the invention, the control circuit controls the detecting circuit to respectively produce the evaluated signal of the base electrode based on one of the parameter sets in order, and the parameter set, on which the evaluated signal of the base electrode firstly conforms to a condition based, is designated as the initial parameter set of the base electrode.

According to the first, second, third, fourth, fifth, sixth and seventh embodiments, the parameter sets could be used to change the delay phase difference, the impedance (resistance value) of the variable resistor, the amplification factor (gain) of the detecting (sensing) circuit, the measurement time (duration of sensing time) of the detecting circuit, the driving time period (duration of driving time) of the driving circuit, the driving potential of the driving circuit and the driving time point of the driving circuit. In a first example of the invention, the detecting circuit connects at least one detecting electrode via a variable resistor, wherein the detecting circuit changes the impedance of the variable resistor based on the initial parameters of the electrodes being provided the driving signal. In a second example of the invention, the detecting circuit changes the duration for detecting signal based on the initial parameters of the electrodes being provided the driving signal. In a third example of the invention, the signal of at least one detecting electrode is provided to the detecting circuit after passing through an amplifier, wherein the amplifier of the detecting circuit changes the amplification factor based on the initial parameters of the electrodes being provided the driving signal. In addition, in a fourth example of the invention, the signal of at least one detecting signal is started to be measured after a delay phase difference, wherein the detecting circuit changes the delay phase difference based on the initial parameters of the electrode being provided the driving signal. In a fifth example of the invention, the driving time period is changed based on the initial parameters of the electrode being provided the driving signal. In a sixth example of the invention, the driving potential is changed based on the initial parameters of the electrode being provided the driving signal. In a seventh example of the invention, the driving time point is changed based on the initial parameters of the electrode being provided the driving signal.

In the second example mentioned above, the duration for detecting signal is changed based on the electrodes being provided the driving signal. Similarly, in the fifth example mentioned above, the driving time period is changed based on the electrodes being provided the driving signal. And also, in the seventh example mentioned above, the driving time point for providing the driving signal is changed based on the electrodes being provided the driving signal. Therefore, detecting time and driving time are all related to the duration of time (or the length of time or the time period).

In one embodiment of the present invention, the driving time and detecting (sensing) time mentioned above are entirely synchronous. In other words, in this situation, the duration of detecting time is equal to that of driving time consequentially. Once the duration of driving time is adjusted, the duration of detecting time also needs to be adjusted. On the contrary, when the duration of detecting time is adjusted, the duration of driving time needs to be adjusted as well. It can be appreciated by one with ordinary skill in the art that when the driving time and the detecting time are completely synchronous, the required energy for driving the electrodes without the detecting time won't be wasted, that is, this embodiment has a higher energy efficiency.

In another embodiment of the present invention, the driving time and the detecting (sensing) time mentioned above, at least in part, are at the same time. In some cases, the duration of detecting time could be equal to that of driving time. However, in part of the detecting time, the related driving electrode does not receive the driving signal, and similarly, in part of the driving time, the detecting circuit does not detect the related detecting electrode. In another cases, the duration of detecting time could be longer than that of driving time, that is, in part of the detecting time, the related driving electrode does not receive the driving signal. In the other cases, the duration of driving time is longer than that of detecting time, that is, in part of the driving time, the detecting circuit does not detect the related detecting electrode. It can be appreciated by one with ordinary skill in the art that the embodiment with the abovementioned driving time and detecting time being at the same time in part only, the energy efficiency thereof is worse than that of the embodiment with the driving time and detecting time being fully synchronous.

However, in the real world, the driving signal sent by the driving circuit needs to be transmitted through the driving electrode and other circuit, and further through the measured detecting electrode and other circuit, and after delaying a delay time or phase difference to reach the detecting circuit. In other words, when the driving time and detecting time are fully at one time, the driving signal could not be received at the initial stage of the detecting time but it could still be received after the end of the detecting time. Therefore, it can be appreciated by one with ordinary skill in the art that the driving time and the detecting time can be completely synchronized by just exactly identifying the delay time and the phase difference thereof. And more specifically, the duration of driving time is the same as that of detecting time but the time point for the detecting time to be started should be later than that for the driving time to the abovementioned phase difference. Also, in the real world, owing to the manufacturing processes of touch panel/screen, the material or impedance for each electrode is different. Besides, the environmental factors, such as humidity and temperature, could have different affections to each electrode. Accordingly, the abovementioned delay time and phase difference cannot be exactly identified.

One of the advantages for at one time or synchronization should be pointed out here, that is, it can accelerate the scanning. In one example, under the situation of the driving time being longer than the detecting time, next one or next set of the driving electrode still needs to wait for and can just be scanned after the end of the driving time even though the detecting time has already been over. However, if the detecting time and the driving time are at the same time or even are synchronized, it is unnecessary to wait for the driving time that next one or next set of the driving electrode can be scanned immediately.

In some embodiments of the present invention, the duration of driving time can be adjusted but the time point for sending the driving signal is an invariable cycle. For example, driving the first driving electrode at time t and stopping driving it at time t+3; driving the second driving electrode at time t+5 and stopping driving it at time t+7.5; and driving the third driving electrode at time t+10 and stopping driving it at time t+12. With respect to the first driving electrode, the driving time continues 3 time units; as for the second driving electrode, the driving time only continues 2.5 time units; and as regards the third driving electrode, the driving time continues 2 time units only. The time points for the adjacent driving electrodes being driven have the interval of 5 time units in average whatever the driving time is changed to, that is, the interval between the time of the second driving electrode being driven and the time of the first driving electrode being driven is 5 time units; and the interval between the time of the third driving electrode being driven and the time of the second driving electrode being driven is 5 time units.

In another some embodiments of the present invention, in addition to adjusting the duration of the driving time, the time point for sending the driving signal can also be adjusted. For example, driving the first driving electrode at time t and stopping driving it at time t+3; driving the second driving electrode at time t+5.5 and stopping driving it at time t+8.5; and driving the third driving electrode at time t+11.5 and stopping driving it at time t+14.5. With respect to the first driving electrode, the driving time continues 3 time units; as for the second driving electrode, the driving time continues 3 time units; and as regards the third driving electrode, the driving time also continues 3 time units. The duration of the driving time has no change but the time points for adjacent driving electrodes being driven are changed, that is, the interval between the time of the second driving electrode being driven and the time of the first driving electrode being driven is 5.5 time units; and the interval between the time of the third driving electrode being driven and the time of the second driving electrode being driven is 6 time units.

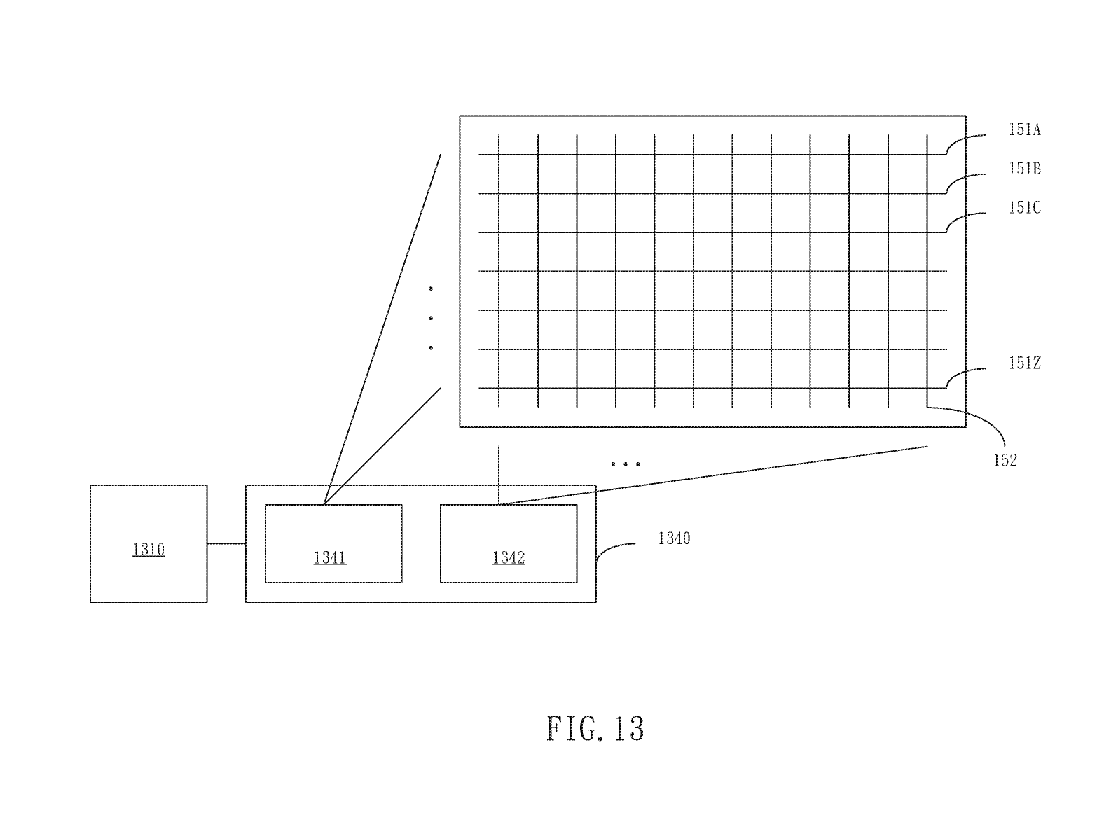

Referring to FIG. 13, a block diagram of a touch sensitive system for one embodiment in accordance with the present invention is illustrated. In this touch sensitive system, it includes a controlling module 1310, a front-end module 1340 and a touch panel or touch screen. The touch panel or touch screen could further include multiple first conductive strips (first strips) or driving conductive strips (driving strips) or driving electrodes 151 and multiple second conductive strips (second strips) or detecting conductive strips (sensing strips) or detecting electrodes (sensing electrodes) 152.

The controlling module 1310 and the front-end module 1340 could be on single integrated circuit (IC) and could also be on several ICs. If they are on single IC, they could also be on the same chip or different chips, and their manufacturing processes could be the same or different. In brief, the present invention is not limited as such.

The front-end module 1340 could include a driving module 1341 and a detecting (sensing) module 1342. Please refer to the driving circuit 41 and the detecting (sensing) circuit 42 as shown in FIG. 4. In one embodiment, the driving module 1341 could include all or part of the driving circuit 41. In one example, the driving module 1341 could receive clock signals and produce driving signals base on the clock signals, and provide the driving signals to one or multiple or all driving electrodes 151 through a driving selecting circuit. The driving signals could be square wave, sinusoid wave or any synthetic wave. The controlling module 1310 can set the waveform, potential, duration of the driving time (driving time period or length) and driving time point of the driving signal based on the driving electrode 151 being driven.

In one embodiment, the detecting module 1342 could include all or part of the detecting circuit 42. In one example, the detecting module 1342 could include a detecting selecting circuit to select to which one or ones detecting electrodes 152 is connected. The detecting module 1342 could include the variable resistor, amplifier, integrator and/or analog to digital converter (A/D converter). The controlling module 1310 can set the resistance value (impedance) of the variable resistor, amplification factor or gain of the amplifier, and/or duration of integrating time of the integrator, and/or the delay phase difference of the integrator, and other controlling options etc. based on the driving electrode 151 being driven.

It can be appreciated by one with ordinary skill in the art that the controlling options for the controlling module 1310, in one embodiment, to the driving module 1341 and the detecting (sensing) module could be selected from several abovementioned preset parameter sets, and the parameter sets could be stored in the controlling module 1310 or other memories. These controlling options could be predetermined, could also be dynamically produced. The present invention is not limited as such.

Applicants would like to specially indicate that the present invention is not limited to whether after receiving the detecting data of the detecting module 1342, such as the abovementioned 1D or 2D sensing information, and then to adjust the sensing information so as to amend the affected sensing information caused by the environment or manufacturing processes. But, one of main spirits for the present invention is to use the controlling module 1310 to control each controlling options of the front-end module 1340 in order to control the front-end module 1340 to firstly amend the affections of the sensing information caused by the layout of the electrode, environment or manufacturing processes.

One of the advantages for amendment at the front-end module 1340 is to avoid the affections of the sensing information caused by the electrode layout, environment or manufacturing process being out of the adjustment range of the controlling module 1310 amending the sensing information subsequently.

Another one of the advantages for amendment at the front-end module 1340 is that the parameter sets required to be stored or controlled by the controlling module 1310 are smaller. For example, when the touch screen has M first conductive strips 151 and N second conductive strips 152, and the controlling module 1310 performs the adjustment and control by seven parameters of the driving signal potential, the driving time length (the duration of driving time), the driving time point, the resistance value (impedance) of the variable resistor, the amplification factor (gain), the detecting time length (the duration of sensing time), detecting (sensing) delay time or phase difference of the detecting (sensing) circuit based on the first conductive strip 151 being driven, in single-electrode scanning mode, the controlling module 1310 only needs to control 7M parameters in maximum. The controlling module 1310 needs to amend M×N sensing information if the subsequent amending processes is still going for image or 2D sensing information. Generally speaking, the quantity for the second conductive strip will be more than seven. Moreover, the embodiments are unlikely to control all seven parameters mentioned above. And hence, the controlling module 1310 needs to perform at least one mathematical operation to M×N sensing information. Similarly, in the multiple-electrode scanning mode, there are the same situations. Therefore, performing the amendment at the front-end module 1340 in advance could effectively reduce the calculation source.

Referring to FIG. 13 again, when the single-electrode scanning is executed, the transmission distance for the driving signal through the driving electrode 151A is farther than that for the driving signal through the driving electrode 151Z. If all options or conditions are the same and keep in constant, the sensing information related to the driving electrode 151A is certainly worse than that related to the driving electrode 1512. In one example for more direct and easier to be understood, the method of adjusting phase difference could be adopted to make the phase difference of detecting the driving electrode 151A bigger than that of detecting the driving electrode 151Z so as to make the two sensing information inclined to level. And, if the problems of material and manufacturing processes for each conductive strips are ignored, the results can be obtained as the phase difference of detecting the driving electrode 151A>the phase difference of detecting the driving electrode 151B>the phase difference of detecting the driving electrode 151C> . . . >the phase difference of detecting the driving electrode 151Z. These phase differences could have liner relationship. Therefore, the controlling module 1310 can calculate the phase difference of detecting each driving electrode 151 by just knowing the phase difference and liner gradient (slope) of detecting the driving electrode 151A.

Furthermore, the methods of adjusting other parameters could also be adopted to make the two sensing information inclined to level. For example, making the driving potential of the driving electrode 151A bigger than that of the driving electrode 151Z so as to make the two sensing information inclined to level. And also, if the problems of material and manufacturing processes for each conductive strips are ignored, the results can be obtained as the driving potential of the driving electrode 151A>the driving potential of the driving electrode 151B>the driving potential of the driving electrode 151C> . . . >the driving potential of the driving electrode 151Z. These driving potentials could have liner relationship. Therefore, the controlling module 1310 can calculate the driving potential of detecting each driving electrode 151 by just knowing the driving potential and liner gradient (slope) of the driving electrode 151A.

Similarly, it can be appreciated by one with ordinary skill in the art that the parameters at least include, but not limited to, the driving signal potential, the driving time length (the duration of driving time), the driving time point, the resistance value (impedance) of the variable resistor, the amplification factor (gain), the detecting time length (the duration of sensing time), the detecting (sensing) delay time or phase difference of the detecting (sensing) circuit being able to be used to execute the adjustment to make the sensing information inclined to level. If a problem caused by the manufacturing processes results in one driving electrode 151 having an extra higher impedance, or the electrical characters of this driving electrode 151 and its adjacent driving electrodes 151 have no a linear relationship, the controlling module 1310 could specially save the parameters for the one or the set of the driving electrodes 151. For example, for the first side and second side driving electrodes 151A and 151Z, both of their shapes and areas could be different from other driving electrodes 151′, and so their electrical characters have no linear relationship to that of their adjacent driving electrodes 151. Therefore, the controlling module 1310 could specially save the parameters for the driving electrodes 151A and 151Z.

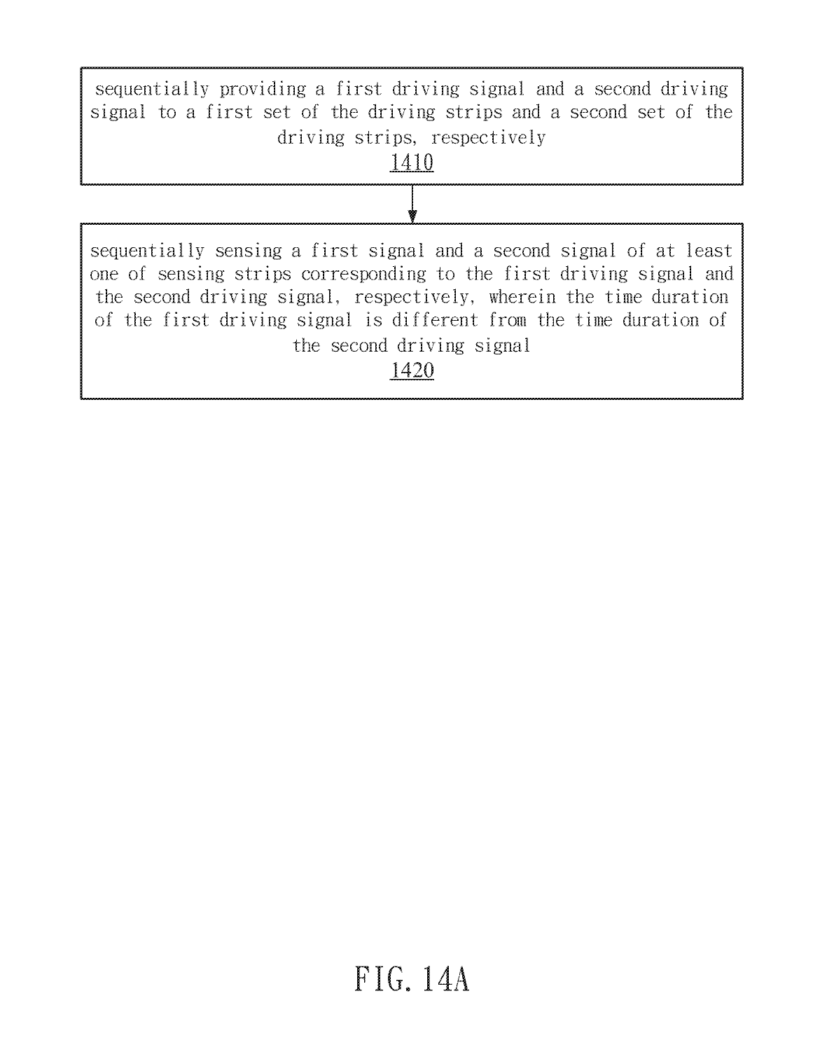

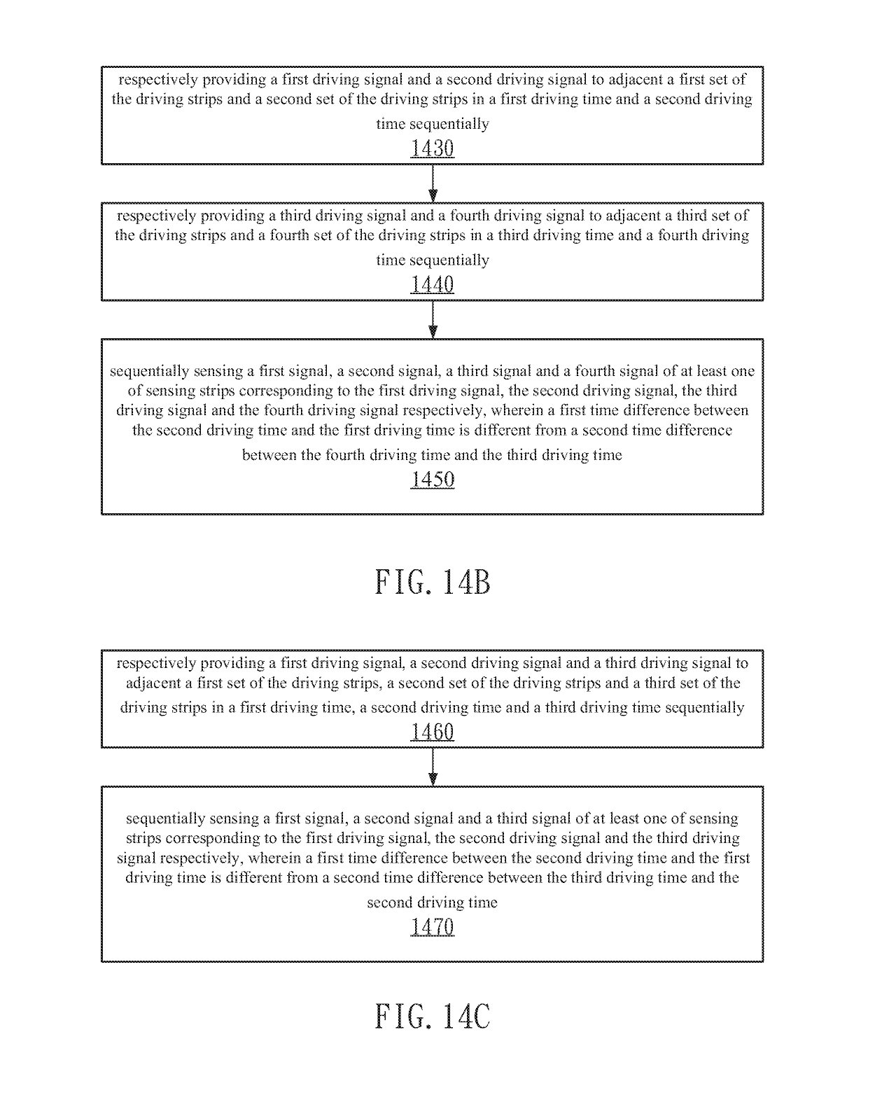

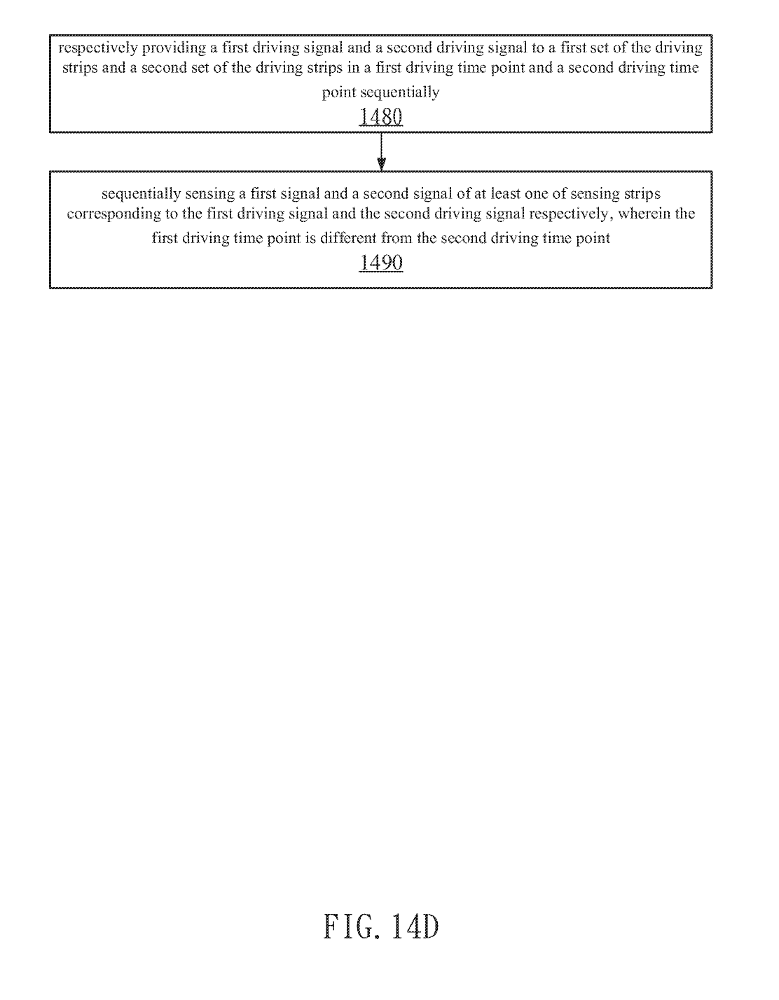

Referring to FIG. 14A, a method for measuring signals of touch sensitive screen for one embodiment in accordance with the present invention is illustrated. Please also refer to the embodiments of FIG. 4 or 13. The touch sensitive screen includes multiple conductive strips including multiple parallel driving strips and multiple parallel sensing strips. The multiple intersecting areas are located at multiple intersections of the driving and sensing strips. The method includes step 1410, sequentially providing a first driving signal and a second driving signal to a first set of the driving strips and a second set of the driving strips, respectively, and step 1420, sequentially sensing a first signal and a second signal of at least one of sensing strips corresponding to the first driving signal and the second driving signal, respectively. Wherein the time duration of the first driving signal is different from the time duration of the second driving signal.

Referring to FIG. 14B, a method for measuring signals of touch sensitive screen for one embodiment in accordance with the present invention is illustrated. Please also refer to the embodiments of FIG. 4 or 13. The touch sensitive screen includes multiple conductive strips including multiple parallel driving strips and multiple parallel sensing strips. The multiple intersecting areas are located at multiple intersections of the driving and sensing strips. The method includes step 1430, respectively providing a first driving signal and a second driving signal to adjacent a first set of the driving strips and a second set of the driving strips in a first driving time and a second driving time sequentially, step 1440, respectively providing a third driving signal and a fourth driving signal to adjacent a third set of the driving strips and a fourth set of the driving strips in a third driving time and a fourth driving time sequentially, and step 1450, sequentially sensing a first signal, a second signal, a third signal and a fourth signal of at least one of sensing strips corresponding to the first driving signal, the second driving signal, the third driving signal and the fourth driving signal respectively. Wherein a first time difference between the second driving time and the first driving time is different from a second time difference between the fourth driving time and the third driving time.

Referring to FIG. 14C, a method for measuring signals of touch sensitive screen for one embodiment in accordance with the present invention is illustrated. Please also refer to the embodiments of FIGS. 4, 13 and 14B. The touch sensitive screen includes multiple conductive strips including multiple parallel driving strips and multiple parallel sensing strips. The multiple intersecting areas are located at multiple intersections of the driving and sensing strips. The method includes step 1460, respectively providing a first driving signal, a second driving signal and a third driving signal to adjacent a first set of the driving strips, a second set of the driving strips and a third set of the driving strips in a first driving time, a second driving time and a third driving time sequentially, step 1470, sequentially sensing a first signal, a second signal and a third signal of at least one of sensing strips corresponding to the first driving signal, the second driving signal and the third driving signal respectively. Wherein a first time difference between the second driving time and the first driving time is different from a second time difference between the third driving time and the second driving time.

Referring to FIG. 14D, a method for measuring signals of touch sensitive screen for one embodiment in accordance with the present invention is illustrated. Please also refer to the embodiments of FIGS. 4, 13, 14B and 14C. The touch sensitive screen includes multiple conductive strips including multiple parallel driving strips and multiple parallel sensing strips. The multiple intersecting areas are located at multiple intersections of the driving and sensing strips. The method includes step 1480, respectively providing a first driving signal and a second driving signal to a first set of the driving strips and a second set of the driving strips in a first driving time point and a second driving time point sequentially, and step 1490, sequentially sensing a first signal and a second signal of at least one of sensing strips corresponding to the first driving signal and the second driving signal respectively. Wherein the first driving time point is different from the second driving time point.

In the present invention, the abovementioned driving time point could be the time difference of the beginning time points provided by two adjacent driving signals, and could also be the time difference of a fixed clock signal.

In one embodiment of the present invention, the touch sensitive screen could include multiple first electrodes paralleled a first axis, multiple second electrodes paralleled a second axis, and multiple dummy electrodes. In one example, a controlling device of the touch sensitive screen could use the first and second electrodes to perform self-capacitive detection to sense the object approaching or touching (or called proximity touching) the touch sensitive screen. In another example, a controlling device of the touch sensitive screen could use the first and second electrodes to perform mutual-capacitive detection to sense the proximity object.

In the traditional technology, the intervals between each first electrode are the same and the intervals between each second electrode are also the same. Generally speaking, the interval for existing design is about 4 mm or even smaller. Since the size of the touch sensitive screen is getting bigger, the required number of the first and second electrodes is also growing. When the number of the electrodes increases, more the winding spaces at the edges of the touch sensitive screen are required and the controlling device of the touch sensitive screen needs more pins or contacts for connection. However, the winding space and the IC's pin are limited. Hence, the present invention reduces the number of the electrodes by the design of different intervals among the electrodes so as to save the winding space and the pins for IC.

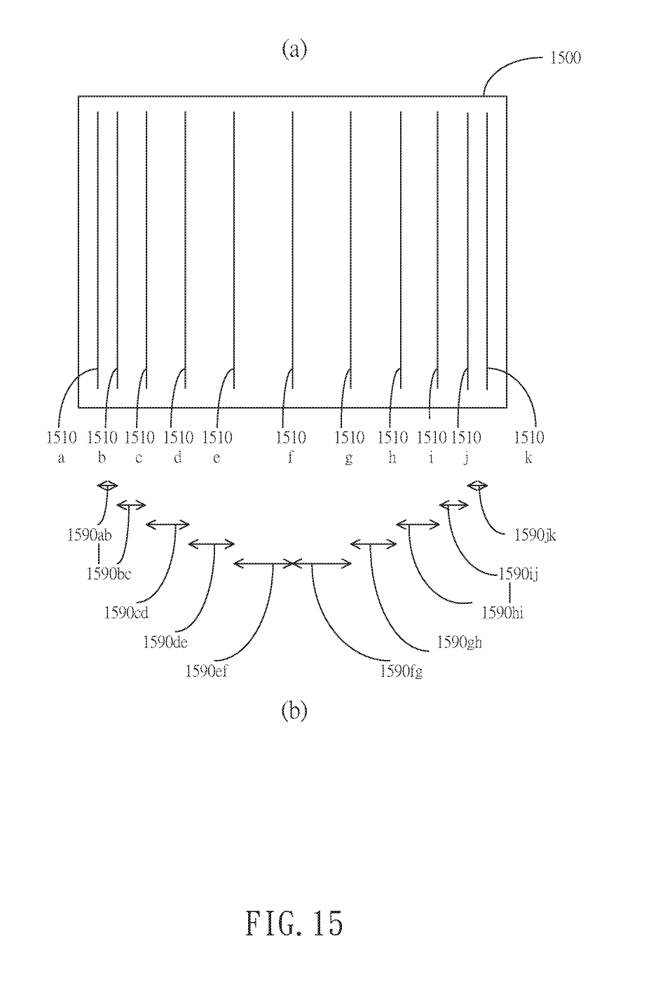

Referring to FIG. 15, an electrode structure of a touch sensitive screen for one embodiment in accordance with the present invention is illustrated. In top half (a) of FIG. 15, it shows a touch sensitive screen 1500 and multiple first electrodes 1510 included by the touch sensitive screen 1500. In FIG. 15, symbols of these first electrodes from left to right are respectively 1510a, 1510b, . . . , and 1510k. However, other numbers of the first electrodes could exist in other embodiments. In one embodiment, the first electrodes 1510 all parallel the first axis, that is, the longitudinal axis of FIG. 15. Although the first electrodes 1510 of FIG. 15 are only illustrated in simple lines, it can be appreciated by one with ordinary skill in the art that the shape of the first electrode 1510 could be variety but the main axis of the first electrode 1510 is along the first axis. However, in FIG. 15, the multiple second electrodes paralleled the second axis and the dummy electrode are not shown.

Paying attention to bottom half (b) of FIG. 15, the intervals among the first electrodes 1510 are specially marked off, called intervals 1590. Interval 1590ab is the distance between the first electrodes 1510a and 1510b, interval 1590bc is the distance between the first electrodes 1510b and 1510c, and so forth, as shown in following Table.

| First | | | Rising \| Falling |
|---|---|---|---|
| electrode | Interval | Interval length | slope |
| 1510a | | | |
| | 1590ab | 2 | |
| 1510b | | | 150% \| 66% |
| | 1590bc | 3 | |
| 1510c | | | 133.3% \| 75% |
| | 1590cd | 4 | |
| 1510d | | | 125% \| 80% |
| | 1590de | 5 | |
| 1510e | | | 120% \| 83% |
| | 1590ef | 6 | |
| 1510f | | | 100% \| 100% |
| | 1590fg | 6 | |
| 1510g | | | 120% \| 83% |
| | 1590gi | 5 | |
| 1510i | | | 125% \| 80% |
| | 1590ij | 4 | |
| 1510j | | | 133.3% \| 75% |
| | 1590jk | 3 | |
| 1510k | | | 150% \| 66% |
| | 1590kl | 2 | |
| 1510l | | | |

In the embodiment of FIG. 15, the intervals getting closer to the middle of the touch sensitive screen 1500 are getting bigger, and those getting closer to the edges of the touch sensitive screen 1500 are getting smaller. The intervals 1590 among the first electrodes 1510 at the middle of the touch sensitive screen 1500 could reach a maximum value. For example, the interval 1590ef is equal to the interval 1590fg, and the intervals 1590ef and 1590fg are the biggest among all intervals 1590. In other words, in several intervals 1590, some intervals have the biggest value, but in another embodiment, only one interval 1590 has a biggest value.

In one embodiment, since there is no any first electrode 1510 being at the middle of the touch sensitive screen 1500, one of the intervals having the maximum value is at the middle of the touch sensitive screen 1500. In another embodiment, if there is one first electrode 1510 being at the middle of the touch sensitive screen 1500, one of the intervals having the maximum value is at the two sides of the intermediate first electrode, such as the first electrode 1510f.

In the embodiment shown in FIG. 15, the layouts for the intervals 1590 are bilateral symmetry based on the middle line of the touch sensitive screen 1500 or the first electrode 1510f as the axis of symmetry. The intervals 1590ef and 1590gh are the corresponding intervals, and their distance is 6 units. This shows the intervals 1590 in FIG. 15 forming a symmetrical structure. However, the present invention does not limit each interval 1590 to form the structure of bilateral symmetry, and does not limit the interval 1590 having the maximum value to be at the middle of or near the middle of the touch sensitive screen 1500.

One of the features of the present invention is a certain first interval being different from a certain second interval. In one embodiment, a certain third interval is different from the first and second intervals. In one embodiment, the first interval is the adjacent interval to the second interval. In another embodiment, the first and second intervals are not next to each other. In one embodiment, if the first interval is bigger than the second interval, the second interval is closer the middle of the touch sensitive screen.

The difference of two adjacent intervals 1590 is called interval slope. To avoid confusion, the interval slope could be defined as a ratio of bigger interval to smaller interval of two adjacent intervals, called rising slope, or could be defined as a ratio of smaller interval to bigger interval of two adjacent intervals, called falling slope. In the far right fields of the above Table show the rising and falling slopes.

In the embodiment shown in FIG. 15, since the layouts of the intervals 1590 are bilateral symmetry, the interval slopes are also symmetrical. For example, the slope of between the intervals 1590ab and 1590bc is equal to that of between the intervals 1590jk and 1590kl based on the middle of the touch sensitive screen 1500 or the first electrode 1510f being the axis of symmetry. In this embodiment, the rising slope is getting lower and the falling slope is getting higher as getting closer the middle of the touch sensitive screen 1500, and the rising slope is getting higher and the falling slope is getting lower as getting farther the middle of the touch sensitive screen 1500. However, the present invention does not limit each interval slope to form the structure of bilateral symmetry, and does not limit the interval rising or falling slope with 100% to be at the middle of or near the middle of the touch sensitive screen.

One of the features of the present invention is a certain first interval slope being different from a certain second interval slope. In one embodiment, a certain third interval slope is different from the first and second interval slopes. In one embodiment, the first interval slope is the adjacent interval slope to the second interval slope. In another embodiment, the first and second interval slopes are not next to each other. In one embodiment, if the first interval rising slope is bigger than the second interval rising slope, the interval corresponding to the second interval rising slope is closer the middle of the touch sensitive screen. If the first interval falling slope is bigger than the second interval falling slope, the interval corresponding to the first interval falling slope is closer the middle of the touch sensitive screen.

For reducing the number of the electrodes, the space of corresponding winding and the pins of IC, in one embodiment of the present invention, the intervals among the electrodes could be enlarged above 4 mm, such as bigger than 4.5 mm, to gradually reach the biggest intervals of 7 mm to 8 mm. However, the numbers mentioned above are only for explanation, and the present invention is not limited to the interval design mentioned above.

If these big intervals are kept on the edges of the touch sensitive screen, and when an object proximally approaches the edges of the touch sensitive screen, the amount of signals sensed by the electrodes being closest to the edges could be reduced to about the same as noise and might be filtered out. Also, since the amount of signals are quite small, the position of the proximity object is very difficult to be calculated. Therefore, the present invention provides the solution for the problem mentioned above. It makes the electrodes being close to the edges of the touch sensitive screen be concentrated gradually, so there are more electrodes can sense the approaching object (or proximity object) and the position thereof can be calculated out more exactly. Besides, the present invention also proposes a design for directly putting the electrodes on the edges of the touch sensitive screen, and this part will be described later.

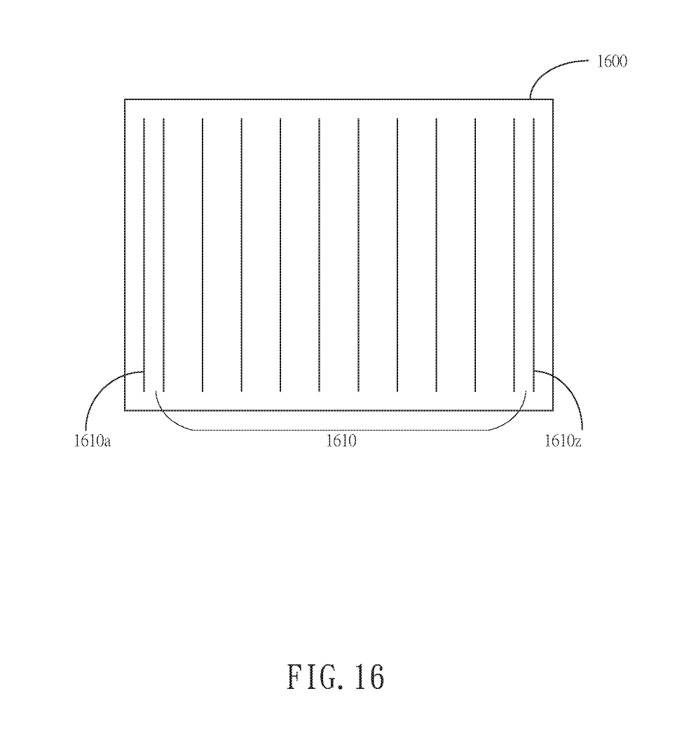

Referring to FIG. 16, an electrode structure for a touch sensitive of one embodiment in accordance with the present invention is illustrated. As the same as the embodiment shown in FIG. 15, the embodiment of FIG. 16 does not show multiple second electrodes being parallel with the second axis and the dummy electrode but only multiple first electrodes 1610 being parallel with the first axis. In this embodiment, except for two first electrodes 1610a and 1610z being closest to the edges, the intervals among other first electrodes 1610 are all the same. In this design, it could use the first electrodes 1610a and 1610z to take the responsibility to sense the approaching object on the edges of the touch sensitive screen, and could also reduce the number of the first electrodes 1610 as small as possible.

In one certain embodiment, the first electrodes 1610a and 1610z are just at the middle of the first electrodes 1610 next to themselves and the edges of the touch sensitive screen 1600, respectively. In one embodiment, the intervals between the electrodes 1610 next to the first electrodes 1610a and 1610z and the edges of the touch sensitive screen are equal to, except for the first electrodes 1610a and 1610z, the intervals among all the first electrodes 1610.

During the mutual capacitive sensing, the position of the proximity object on the touch sensitive screen 1600 can be calculated based on the locations of each first electrodes 1610 and the amount of sensed signals. If the designed shape of a certain first electrode 1610 is the same as that of others, the amount of sensed signal of the certain first electrode 1610 is unnecessary to be adjusted. For example, in the embodiment of FIG. 16, the shape of the first electrode 1610a and the shape of other first electrodes 1610 are the same in the strip shape, and their areas are also the same, thus the amount of sensed signal of the first electrode 1610a is unnecessary to be adjusted. However, if the designed shape of a certain first electrode is different from that of others, the amount of sensed signal thereof needs to be adjusted.

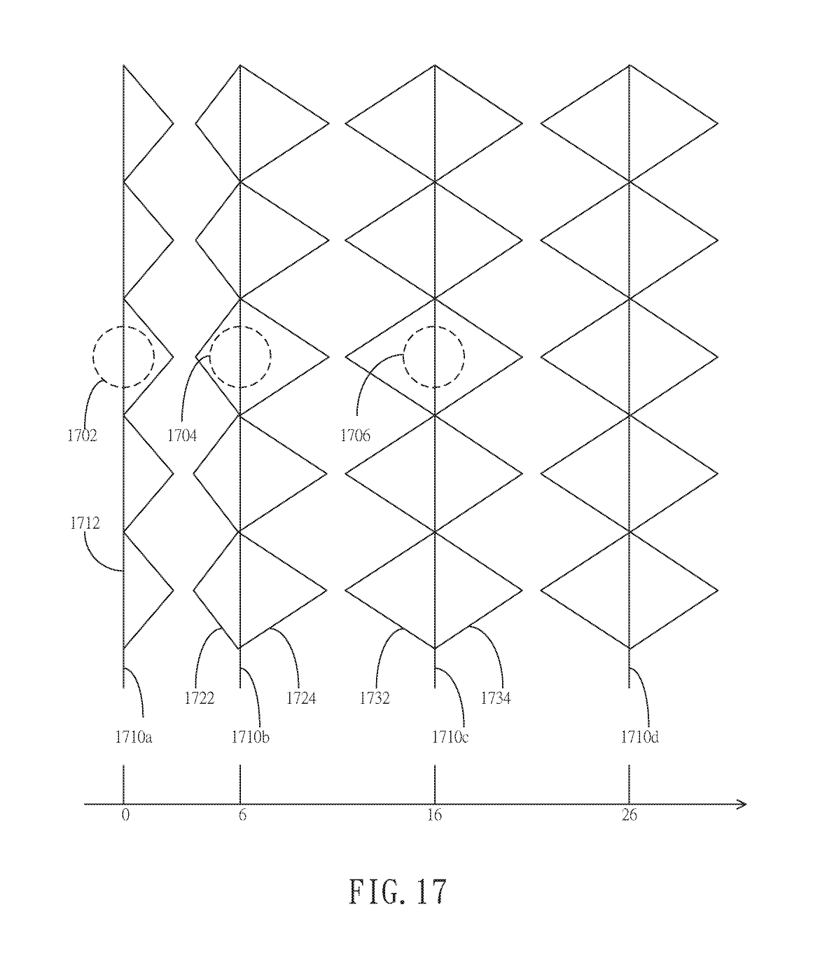

Referring to FIG. 17, a part of electrode structure for a touch sensitive screen in accordance with the present invention is illustrated. As the same as the embodiment shown in FIG. 15, the embodiment of FIG. 17 does not show multiple second electrodes being parallel with the second axis and the dummy electrode but only multiple first electrodes 1710 being parallel with the first axis (the longitudinal axis). The embodiment shown in FIG. 17 includes 4 first electrodes 1710. The first electrode 1710a is on the far left and its position on the second axis (the lateral axis) is 0. The first electrode 1710a includes multiple triangle conductive sheets 1712. Since the first electrode 1710a is on the left edge of the touch sensitive screen, the conductive sheets 1712 are on the right side of the first electrode 1710a and extend to the right about 2.5 units.

The position of the first electrode 1710b on the second axis is 6. The first electrode 1710b includes multiple rectangle conductive sheets and each rectangle conductive sheet consists of two left and right triangle conductive sheets 1722 and 1724. The left triangle conductive sheets 1722 have the same shape as the triangle conductive sheets 1712 but in opposite direction. They are extended to left about 2.5 units from the first electrode 1710b. The right triangle conductive sheets 1724 have the same shape as the triangle conductive sheets 1732 but in opposite direction. They are extended to right about 4.5 units from the first electrode 1710b.

Three types of first electrodes 1710 can be found in FIG. 17. The first electrode 1710a belongs to the first type. It is on the edge of the touch sensitive screen and its shape is just partial to one side. The first electrode 1710b goes to the second type. It is on the middle of the touch sensitive screen and its shape is asymmetrical since the intervals at its both sides are different. The first electrode 1710c goes to the third type. It is on the middle of the touch sensitive screen and its shape is symmetrical because the intervals at its both sides are the same.

If one and the same proximity object respectively proximally touches the different positions of 1702, 1704 and 1706, the amounts of their sensed signals are different since the shapes of the first electrodes 1710 for each position are different. For example, in the embodiment shown in FIG. 3, the area proportions of the related conductive sheets for the first electrodes 1710a, 1710b and 1710c are 2.5:7:9. When the proximity object at the position 1702, the area of the conductive sheet 1712 for the first electrode 1710a is smaller than the sum of areas of the conductive sheets 1722 and 1724 for the first electrode 1710b when the proximity object at the position 1704. Besides, the first electrode 1710c might not senses signal when the proximity object at the position 1702. However, the first electrodes 1710a and 1710c can still senses signal when the proximity object at the position 1704.

It can be appreciated by one with ordinary skill in the art that the embodiment shown in FIG. 17 uses the triangle conductive sheet to be the shape of the electrode but the present invention is not limited as such. For example, the shapes for the electrode could also be hexagon, octagon, polygon, spiral in rectangle, spiral in circle, and so forth.

Compared to the embodiments shown in FIGS. 15 and 16, the embodiment shown in FIG. 17 has one more first electrode 1710a on the edge of the touch sensitive screen. Compared to the first electrodes 1610a and 1610z shown in FIG. 16, the first electrode 1710a is more closer to the edge of the touch sensitive screen, and hence it has the better sensing effect to the proximity object on the edge of the touch sensitive screen.

As mentioned above, since the shapes of the first and second types of first electrodes 1710a and 1710b have different designs, the amounts of signals sensed by these two types of electrodes need to be adjusted. The process for the adjustment could be that the amounts of sensed signals multiply by a factor, and this factor could be obtained by looking up table or based on a certain function calculation. In one embodiment, the function could be a linear function or a quadratic function. In one embodiment, this factor could relate to the area of conductive sheet or the area of conductive sheet of adjacent electrode or the interval of adjacent electrode.

In addition to adjusting the amount of sensed signal by multiplying a factor in digital process, it can also be firstly adjusted in an analog front end (AFE) circuit. The present invention can include the adjustment in the front end of digital process, could also include the adjustment in digital process, and could include both of them as well. Once the steps and/or the factors of these adjustments relate to the different intervals of adjacent electrode, the different sensing areas owing to different intervals, or the areas of different conductive sheets, they are all included in the range of the present invention.

In one embodiment, it adopts the mutual capacitive sensing, providing the driving signal to the second electrodes paralleled the second axis subsequently, and sensing the amount of sensed signal for each first electrode so as to sense the proximity object. With the part of connecting driving each second electrode, the AFE circuit can control the driving time length (duration of driving time) and the potential of the driving signal. With the part of connecting each first electrode, the AFE circuit can provides the variable resistor, the amplifier and the integrator to sense the amount of sensed signal mentioned above. Therefore, the AFE circuit can control factors of the resistance value (impedance) of the variable resistor, the gain value of the amplifier, the integrating time point (or called the phase difference or the time difference to the driving signal) of the integrator, the integrating time length (duration of integrating time), and so on.

Hence, the AFE circuit can adjusts one or any combination of the abovementioned factors to change the amount of sensed signal based on each second electrode being provided the driving signal. In one embodiment, based on the areas of the related conductive sheets, the gain factor of the amplifier for the first electrode 1710a can be changed to 9/2.5 times of the gain factor of the amplifier for the first electrode 1710c, the gain factor of the amplifier for the first electrode 1710b can be changed to 9/7 times of the gain factor of the amplifier for the first electrode 1710c. In another embodiment, the resistance value (impedance) of the variable resistor for the first electrode 1710b can be changed to 7/2.5 times of the resistance value (impedance) of the variable resistor for the first electrode 1710a, the resistance value of the variable resistor for the first electrode 1710b can be changed to 9/2.5 times of the resistance value of the variable resistor for the first electrode 1710a.

When the mutual capacitive sensing is adopted to sense the proximity object, the difference and/or dual difference (that is the difference of two differences) of sensed signal of adjacent first electrode 110 could be used to reduce the noise interference, and then to perform the subsequent judgement. The difference and/or dual difference are/is subjected to the values, which have been adjusted to, to perform subtraction. Similarly, in one embodiment, the adjustment could be directly executed in the AFE circuit and could also perform the operation of the difference and/or dual difference in the AFE circuit directly. Or, it could be held until the digital process and then to perform the operation of the difference and/or dual difference.

In the above embodiments, multiple interval slopes being not 100% are different. In one embodiment, for convenient design or calculation, the interval slopes being not 100% are set in a certain range. For example, the interval slope could be set to 5%±1%. Accordingly, the adjustment processes mentioned above could be simplified. If the interval slope is set to smaller or the inaccurate position of the proximity object could be accepted, the interval slope could even be ignored.

One of the features of the present invention is that a certain first interval slope is equal to a certain second interval slope and both of them are not 100%. In one embodiment, the difference between the first interval slope and the second interval slope is within a range. In one embodiment, the first and second interval slopes are adjacent interval slope. In another embodiment, the first and second interval slopes are not adjacent interval slope.

In the embodiments of FIGS. 1-3, they all use the first electrodes paralleled the first axis for explanation. However, it can be appreciated by one with ordinary skill in the art that the different interval design could be adopted to the second electrodes paralleled the second axis to reduce the winding space of the second electrodes and IC pins.

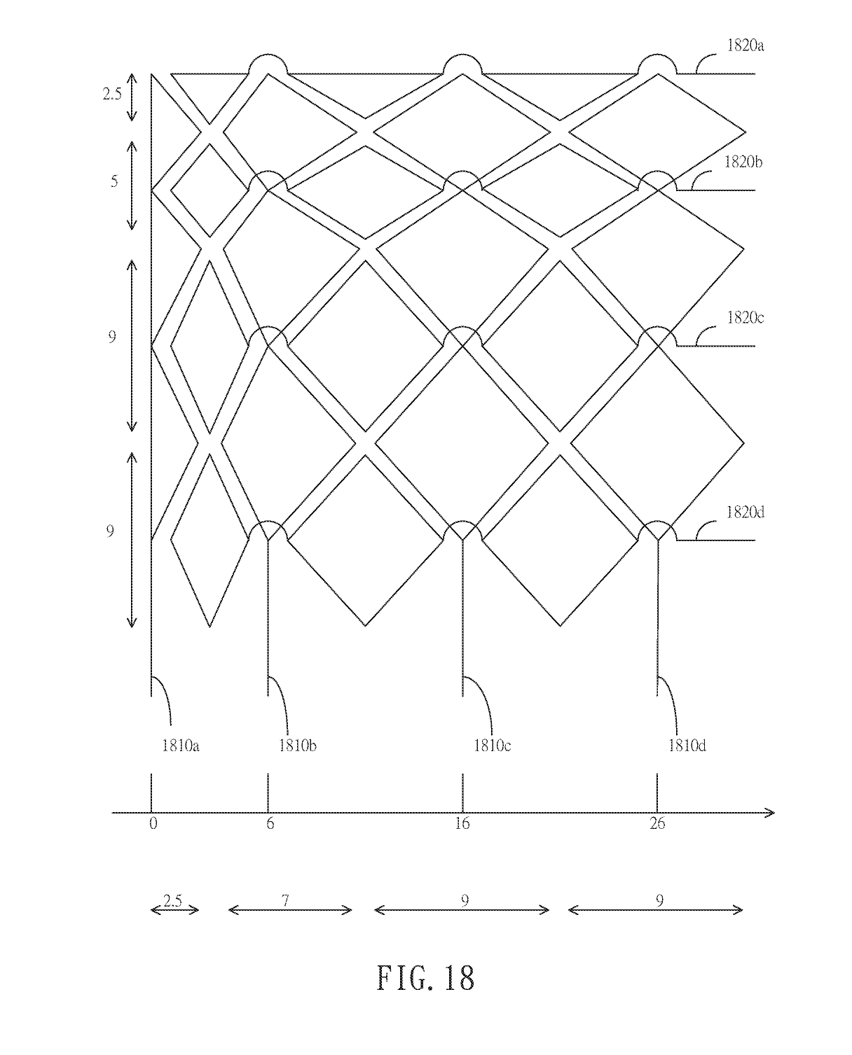

Referring to FIG. 18, a part of electrode structure for a touch sensitive screen in accordance with the present invention is illustrated. With different from 3 figures prior to the fourth figure, this figure shows the first electrode 1810 with three types and the second electrode 1820.

FIG. 18 shows the top left corner of a touch sensitive screen, the second electrode 1820a is on the upper edge of the touch sensitive screen. It can be appreciated by one with ordinary skill in the art that the first electrodes 1810 and the second electrodes 1820 could be on the same substrate or different substrates. When they are on different substrates, each conductive sheets of the second electrode 1820 could have no bridge. When they are on the same substrate, one of the conductive sheets of the first and second electrodes 1810 and 1820 needs to build bridges among each conductive sheets so as to electrically couple each conductive sheets. The second electrode 1820 could connect the controlling device via its left side but its right side. For convenient to draw and easy to understand, FIG. 18 shows building bridges among each conductive sheets of the second electrode 1820. It can be appreciated by one with ordinary skill in the art that FIG. 18 only shows one of the embodiments and the present invention can still apply to the above variety.

The second electrode 1820a is the same as the first electrode 1810a and belongs to the first type mentioned above. Both of them are on the edge of the touch sensitive screen, and thus their related conductive sheets or electrode design just includes a half. The second electrode 1820b is the same as the first electrode 1820b and belongs to the second type mentioned above. Its related conductive sheets are rectangle. Compared with the first electrode 1710b shown in FIG. 17, the conductive sheets of the first electrode 1810b shown in FIG. 18 are asymmetrical rhombus. The second electrode 1820c is the same as the first electrode 1810c and belongs to the third type mentioned above.

When the same driving signal respectively sends to the second electrodes 1820a and 1820b, they produce different sensing values corresponding to the same first electrode 1810 since the areas of their conductive sheets are different from the intervals of other second electrodes 1820. As those mentioned above, the present invention can adjust the sensing value by the AFE circuit and/or digital process. Moreover, the above adjustment is performed based on different second electrodes 1820 being provided the driving signal.

In one embodiment, the potential for driving the second electrode 1820a could be adjusted to higher than that for driving the second electrode 1820b. The potential for driving the second electrode 1820b could be adjusted to higher than that for driving the second electrode 1820c. In another embodiment, when the same driving signal is provided to the second electrode 1820a, the AFE circuit could adjust the resistance value of the variable resistor to lower than that with the same driving signal being provided to the second electrode 1820b. When the same driving signal is provided to the second electrode 1820b, the AFE circuit could adjust the resistance value of the variable resistor to lower than that with the same driving signal being provided to the second electrode 1820c.

It can be appreciated by one with ordinary skill in the art that in the receiving part of the AFE circuit, it could direct to different second electrodes 1820 being driven to perform the adjustment, and in addition, it could further direct to different first electrodes 1810 to perform the adjustment at the same time. In one embodiment, if there are M first electrodes 1810 and N second electrodes 1820 and one entire sensing for the touch sensitive screen is executed, the AFE circuit can control M×N sets of factors in maximum. Each set of factors could include one or any combination of the abovementioned factors. The factors could include, but not limited to, the driving time length (duration of driving time) for the driving signal and driving signal potential at the driving side, and the resistance value (impedance) of the variable resistor, the gain of the amplifier, the integrating time point (or called the phase difference or time difference to the driving signal) of the integrator and the integrating time length (duration of integrating time) at the receiving side.

In some certain embodiments, the driving signal can be provided to one set with two or more than two second electrodes 1820, and hence the number for the set of the factors in maximum could be the product of the number of the set of driven second electrode 1820 and N. It can be appreciated by one with ordinary skill in the art that in some certain embodiments, it is unnecessary to direct to each set of factor to perform the adjustment.

According to each embodiment mentioned above and the variety thereof, the present invention provides a touch sensitive screen with the electrode design having different intervals and the method for mutual capacitive sensing thereof. The touch sensitive screen based on the present invention can enlarge the intervals among the electrodes, reduce the number of the electrodes and keep or even improve the sensing performance on the edge of the touch sensitive screen so as to reduce the winding space and the IC pins.

In one embodiment of the present invention, it provides an apparatus for measuring signals of touch sensitive screen. This apparatus could be the front end module 1340 of FIG. 13. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit sequentially provides a first driving signal and a second driving signal to a first set of the driving strips and a second set of the driving strips, respectively. The sensing circuit sequentially senses a first signal and a second signal of at least one of sensing strips corresponding to the first driving signal and the second driving signal, respectively. Wherein, the time duration of the first driving signal is different from the time duration of the second driving signal.

In another embodiment of the present invention, it offers a method for measuring signals of touch sensitive screen. This method could be those steps shown in FIG. 14A. The touch sensitive screen includes multiple conductive strips having multiple parallel driving strips and multiple parallel sensing strips, wherein multiple intersecting areas are located at multiple intersections of the driving and sensing strips. The method includes sequentially providing a first driving signal and a second driving signal to a first set of the driving strips and a second set of the driving strips, respectively, and sequentially sensing a first signal and a second signal of at least one of sensing strips corresponding to the first driving signal and the second driving signal, respectively. Wherein, the time duration of the first driving signal is different from the time duration of the second driving signal.

In one embodiment of the present invention, it provides an apparatus for measuring signals of touch sensitive screen. This apparatus could be the front end module 1340 of FIG. 13. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit sequentially provides a first driving signal and a second driving signal to a first set of the driving strips and a second set of the driving strips, respectively. The sensing circuit sequentially senses a first signal and a second signal of at least one sensing strip corresponding to the first driving signal and the second driving signal, respectively. Wherein, at least one of the following conditions or any combination thereof is satisfied: the sensing circuit connecting the at least one sensing strip via a variable resistor, the variable resistor being set to a first resistance value as the sensing circuit generating the first signal, the variable resistor being set to a second resistance value as the sensing circuit generating the second signal, the first resistance value being different from the second resistance value; the sensing circuit using a first sensing time duration to produce the first signal, the sensing circuit using a second sensing time duration to produce the second signal, the first sensing time duration being different from the second sensing time duration; the sensing circuit connecting the at least one sensing strip via an amplifier, the amplifier being set to a first gain as the sensing circuit generating the first signal, the amplifier being set to a second gain as the sensing circuit generating the second signal, the first gain being different from the second gain; the sensing circuit producing the first signal after a first delay phase difference, the sensing circuit producing the second signal after a second delay phase difference, the first delay phase difference being different from the second delay phase difference; the potential of the first driving signal being different from the potential of the second driving signal; and the driving time duration of the first driving signal being different from the driving time duration of the second driving signal.

In another embodiment of the present invention, it offers a method for measuring signals of touch sensitive screen. The touch sensitive screen includes multiple conductive strips having multiple parallel driving strips and multiple parallel sensing strips, wherein multiple intersecting areas are located at multiple intersections of the driving and sensing strips. The method includes sequentially providing a first driving signal and a second driving signal to a first set of the driving strips and a second set of the driving strips, respectively, and sequentially sensing a first signal and a second signal of at least one of sensing strips corresponding to the first driving signal and the second driving signal, respectively. Wherein, at least one of the following conditions or any combination thereof is satisfied: the sensing circuit connecting the at least one sensing strip via a variable resistor, the variable resistor being set to a first resistance value as the sensing circuit generating the first signal, the variable resistor being set to a second resistance value as the sensing circuit generating the second signal, the first resistance value being different from the second resistance value; the sensing circuit using a first sensing time duration to produce the first signal, the sensing circuit using a second sensing time duration to produce the second signal, the first sensing time duration being different from the second sensing time duration; the sensing circuit connecting the at least one sensing strip via an amplifier, the amplifier being set to a first gain as the sensing circuit generating the first signal, the amplifier being set to a second gain as the sensing circuit generating the second signal, the first gain being different from the second gain; the sensing circuit producing the first signal after a first delay phase difference, the sensing circuit producing the second signal after a second delay phase difference, the first delay phase difference being different from the second delay phase difference; the potential of the first driving signal being different from the potential of the second driving signal; and the driving time duration of the first driving signal being different from the driving time duration of the second driving signal.

In one embodiment of the present invention, it provides a touch sensitive system including the above touch sensitive screen and apparatus for measuring signals of touch sensitive screen.

In one embodiment, the driving time duration of the first driving signal and the driving time duration of the second driving signal are two sets of parameters in the multiple sets of parameters.

In one embodiment, a time duration ratio between the driving time duration of the first driving signal and the driving time duration of the second driving signal corresponds to one or any combination of following parameters: an area ratio of the first set of the driving strips and the second set of the driving strips; and an interval ratio of the interval between the first set of the driving strips and adjacent the driving strings and the interval between the second set of the driving strips and adjacent the driving strings.

In one embodiment, a potential ratio between the driving time duration of the first driving signal and the driving time duration of the second driving signal corresponds to one or any combination of following parameters: an area ratio of the first set of the driving strips and the second set of the driving strips; and an interval ratio of the interval between the first set of the driving strips and adjacent the driving strings and the interval between the second set of the driving strips and adjacent the driving strings.

In one embodiment, the sensing circuit uses a first sensing time duration to produce the first signal and uses a second sensing time duration to produce the second signal. Wherein, the first sensing time duration corresponds to the driving time duration of the first driving signal and the second sensing time duration corresponds to the driving time duration of the second driving signal.

In one embodiment, the first sensing time duration is equal to the driving time duration of the first driving signal, the second sensing time duration is equal to the driving time duration of the second driving signal, the first sensing time duration is different from the second sensing time duration.

In one embodiment, the first sensing time duration is longer than the driving time duration of the first driving signal, the second sensing time duration is longer than the driving time duration of the second driving signal.

In one embodiment, the sensing circuit produces the first signal after a first delay phase difference and produces the second signal after a second delay phase difference, wherein the first delay phase difference is different from the second delay phase difference.

In one embodiment, the first set of driving strip includes one or multiple continuous the driving strips, the second set of driving strip includes one or multiple continuous the driving strips, the first set of driving strip and the second set of driving strip include the same amount of the driving strips.

In one embodiment, the first set of the driving strip and the second set of the driving strip exclude any side of driving strip of the touch sensitive screen.

In one embodiment, the driving circuit and the sensing circuit are one part of front-end module.

In one embodiment of the present invention, it provides an apparatus for measuring signals of touch sensitive screen. This apparatus could be the front end module 1340 of FIG. 13. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit respectively provides a first driving signal and a second driving signal to a first set of the driving strips and a second set of the driving strips in a first driving time point and a second driving time point sequentially. The sensing circuit sequentially senses a first signal and a second signal of at least one sensing strip corresponding to the first driving signal and the second driving signal, respectively. Wherein, the first driving time point is different from the second driving time point.

In another embodiment of the present invention, it offers a method for measuring signals of touch sensitive screen. This method could be those steps shown in FIG. 14D. The touch sensitive screen includes multiple conductive strips having multiple parallel driving strips and multiple parallel sensing strips, wherein multiple intersecting areas are located at multiple intersections of the driving and sensing strips. The method includes respectively providing a first driving signal and a second driving signal to a first set of the driving strips and a second set of the driving strips in a first driving time point and a second driving time point sequentially, and sequentially sensing a first signal and a second signal of at least one sensing strip corresponding to the first driving signal and the second driving signal, respectively. Wherein, the first driving time point is different from the second driving time point.

In one embodiment of the present invention, it provides an apparatus for measuring signals of touch sensitive screen. This apparatus could be the front end module 1340 of FIG. 13. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit respectively provides a first driving signal and a second driving signal to adjacent a first set of the driving strips and a second set of the driving strips in a first driving time point and a second driving time point sequentially. The driving circuit respectively provides a third driving signal and a fourth driving signal to adjacent a third set of the driving strips and a fourth set of the driving strips in a third driving time point and a fourth driving time point sequentially. The sensing circuit sequentially senses a first signal, a second signal, a third signal and a fourth signal of at least one sensing strip corresponding to the first driving signal, the second driving signal, the third driving signal and the fourth driving signal, respectively. Wherein, a first time difference of the second driving time and the first driving time is different from a second time difference of the fourth driving time and the third driving time.

In another embodiment of the present invention, it offers a method for measuring signals of touch sensitive screen. This method could be those steps shown in FIG. 14B. The touch sensitive screen includes multiple conductive strips having multiple parallel driving strips and multiple parallel sensing strips, wherein multiple intersecting areas are located at multiple intersections of the driving and sensing strips. The method includes respectively providing a first driving signal and a second driving signal to adjacent a first set of the driving strips and a second set of the driving strips in a first driving time point and a second driving time point sequentially, respectively providing a third driving signal and a fourth driving signal to adjacent a third set of the driving strips and a fourth set of the driving strips in a third driving time point and a fourth driving time point sequentially, and sequentially senses a first signal, a second signal, a third signal and a fourth signal of at least one sensing strip corresponding to the first driving signal, the second driving signal, the third driving signal and the fourth driving signal, respectively. Wherein, a first time difference of the second driving time and the first driving time is different from a second time difference of the fourth driving time and the third driving time.

In one embodiment of the present invention, it provides an apparatus for measuring signals of touch sensitive screen. This apparatus could be the front end module 1340 of FIG. 13. The touch sensitive screen includes multiple conductive strips having multiple parallel driving strips and multiple parallel sensing strips, wherein multiple intersecting areas are located at multiple intersections of the driving and sensing strips. The apparatus includes a driving circuit and a sensing circuit. The driving circuit respectively provides a first driving signal, a second driving signal and a third driving signal to adjacent a first set of the driving strips, a second set of the driving strips and a third set of the driving strips in a first driving time point, a second driving time point and a third driving time point sequentially. The sensing circuit sequentially senses a first signal, a second signal and a third signal of at least one sensing strip corresponding to the first driving signal, the second driving signal and the third driving signal, respectively. Wherein, a first time difference of the second driving time and the first driving time is different from a second time difference of the third driving time and the second driving time.

In another embodiment of the present invention, it offers a method for measuring signals of touch sensitive screen. This method could be those steps shown in FIG. 14C. The touch sensitive screen includes multiple conductive strips having multiple parallel driving strips and multiple parallel sensing strips, wherein multiple intersecting areas are located at multiple intersections of the driving and sensing strips. The method includes respectively providing a first driving signal, a second driving signal and a third driving signal to adjacent a first set of the driving strips, a second set of the driving strips and a third set of the driving strips in a first driving time point, a second driving time point and a third driving time point sequentially, and sequentially sensing a first signal, a second signal and a third signal of at least one sensing strip corresponding to the first driving signal, the second driving signal and the third driving signal, respectively. Wherein, a first time difference of the second driving time and the first driving time is different from a second time difference of the third driving time and the second driving time.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An apparatus for measuring signals of touch sensitive screen, which comprises multiple conductive strips including multiple parallel driving strips and multiple parallel sensing strips, wherein multiple intersecting areas are located at multiple intersections of the driving and sensing strips, the apparatus comprising:
a driving circuit, sequentially providing a first driving signal and a second driving signal to a first set of the driving strips and a second set of the driving strips, respectively; and
a sensing circuit, sequentially sensing a first signal and a second signal of at least one of sensing strips corresponding to the first driving signal and the second driving signal, respectively,
wherein the time duration of the first driving signal is different from the time duration of the second driving signal.

2. The apparatus of claim 1, wherein a time duration ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

3. The apparatus of claim 1, wherein a potential ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

4. The apparatus of claim 1, wherein the sensing circuit uses a first sensing time duration to produce the first signal and uses a second sensing time duration to produce the second signal, wherein the first sensing time duration corresponds to the driving time duration of the first driving signal and the second sensing time duration corresponds to the driving time duration of the second driving signal.

5. The apparatus of claim 4, wherein the first sensing time duration is equal to the driving time duration of the first driving signal, the second sensing time duration is equal to the driving time duration of the second driving signal, the first sensing time duration is different from the second sensing time duration.

6. The apparatus of claim 4, wherein the first sensing time duration is longer than the driving time duration of the first driving signal, the second sensing time duration is longer than the driving time duration of the second driving signal.

7. The apparatus of claim 1, wherein the sensing circuit produces the first signal after a first delay phase difference and produces the second signal after a second delay phase difference, wherein the first delay phase difference is different from the second delay phase difference.

8. The apparatus of claim 1, wherein the first set of driving strips includes one or multiple continuous the driving strips, the second set of driving strips includes one or multiple continuous the driving strips, the first set of driving strips and the second set of driving strips include the same amount of the driving strips.

9. The apparatus of claim 1, wherein the first set of the driving strips and the second set of the driving strips exclude any side of driving strip of the touch sensitive screen.

10. The apparatus of claim 1, wherein the driving circuit and the sensing circuit are one part of front-end module.

11. A method for measuring signals of touch sensitive screen, which comprises multiple conductive strips including multiple parallel driving strips and multiple parallel sensing strips, wherein multiple intersecting areas are located at multiple intersections of the driving and sensing strips, the method comprising:
sequentially providing a first driving signal and a second driving signal to a first set of the driving strips and a second set of the driving strips, respectively; and
sequentially sensing a first signal and a second signal of at least one of sensing strips corresponding to the first driving signal and the second driving signal, respectively,
wherein the time duration of the first driving signal is different from the time duration of the second driving signal.

12. The method of claim 11, wherein a time duration ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

13. The method of claim 11, wherein a potential ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

14. The method of claim 11, wherein the sensing circuit uses a first sensing time duration to produce the first signal and uses a second sensing time duration to produce the second signal, wherein the first sensing time duration corresponds to the driving time duration of the first driving signal and the second sensing time duration corresponds to the driving time duration of the second driving signal.

15. The method of claim 14, wherein the first sensing time duration is equal to the driving time duration of the first driving signal, the second sensing time duration is equal to the driving time duration of the second driving signal, the first sensing time duration is different from the second sensing time duration.

16. The method of claim 14, wherein the first sensing time duration is longer than the driving time duration of the first driving signal, the second sensing time duration is longer than the driving time duration of the second driving signal.

17. The method of claim 11, wherein the sensing circuit produces the first signal after a first delay phase difference and produces the second signal after a second delay phase difference, wherein the first delay phase difference is different from the second delay phase difference.

18. An apparatus for measuring signals of touch sensitive screen, which comprises multiple conductive strips including multiple parallel driving strips and multiple parallel sensing strips, wherein multiple intersecting areas are located at multiple intersections of the driving and sensing strips, the apparatus comprising:
a driving circuit, sequentially providing a first driving signal and a second driving signal to a first set of the driving strips and a second set of the driving strips, respectively; and
a sensing circuit, sequentially sensing a first signal and a second signal of at least one sensing strips corresponding to the first driving signal and the second driving signal, respectively,
wherein at least one of the following conditions or any combination thereof is satisfied:
the sensing circuit connecting the at least one sensing strip via a variable resistor, the variable resistor being set to a first resistance value as the sensing circuit generating the first signal, the variable resistor being set to a second resistance value as the sensing circuit generating the second signal, the first resistance value being different from the second resistance value;
the sensing circuit using a first sensing time duration to produce the first signal, the sensing circuit using a second sensing time duration to produce the second signal, the first sensing time duration being different from the second sensing time duration;
the sensing circuit connecting the at least one sensing strip via an amplifier, the amplifier being set to a first gain as the sensing circuit generating the first signal, the amplifier being set to a second gain as the sensing circuit generating the second signal, the first gain being different from the second gain;
the sensing circuit producing the first signal after a first delay phase difference, the sensing circuit producing the second signal after a second delay phase difference, the first delay phase difference being different from the second delay phase difference;
the potential of the first driving signal being different from the potential of the second driving signal;
a first driving time point for providing the first driving signal being different from a second driving time point for providing the second driving signal; and
the driving time duration of the first driving signal being different from the driving time duration of the second driving signal.

19. The apparatus of claim 18, wherein a time duration ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

20. The apparatus of claim 18, wherein a potential ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

21. The apparatus of claim 18, wherein the first sensing time duration corresponds to the driving time duration of the first driving signal, the second sensing time duration corresponds to the driving time duration of the second driving signal.

22. The apparatus of claim 21, wherein the first sensing time duration is equal to the driving time duration of the first driving signal, the second sensing time duration is equal to the driving time duration of the second driving signal, the first sensing time duration is different from the second sensing time duration.

23. The apparatus of claim 21, wherein the first sensing time duration is longer than the driving time duration of the first driving signal, the second sensing time duration is longer than the driving time duration of the second driving signal.

24. The apparatus of claim 18, wherein the first delay phase difference is different from the second delay phase difference.

25. The apparatus of claim 18, wherein the first set of driving strips includes one or multiple continuous the driving strips, the second set of driving strips includes one or multiple continuous the driving strips, the first set of driving strips and the second set of driving strips include the same amount of the driving strips.

26. The apparatus of claim 18, wherein the first set of the driving strips and the second set of the driving strips exclude any side of driving strip of the touch sensitive screen.

27. The apparatus of claim 18, wherein the driving circuit and the sensing circuit are one part of front-end module.

28. A method for measuring signals of touch sensitive screen, which comprises multiple conductive strips including multiple parallel driving strips and multiple parallel sensing strips, wherein multiple intersecting areas are located at multiple intersections of the driving and sensing strips, the method comprising:
sequentially providing a first driving signal and a second driving signal to a first set of the driving strips and a second set of the driving strips, respectively; and
sequentially sensing a first signal and a second signal of at least one of sensing strips corresponding to the first driving signal and the second driving signal, respectively,
wherein at least one of the following conditions or any combination thereof is satisfied:
the sensing circuit connecting the at least one sensing strip via a variable resistor, the variable resistor being set to a first resistance value as the sensing circuit generating the first signal, the variable resistor being set to a second resistance value as the sensing circuit generating the second signal, the first resistance value being different from the second resistance value;
the sensing circuit using a first sensing time duration to produce the first signal, the sensing circuit using a second sensing time duration to produce the second signal, the first sensing time duration being different from the second sensing time duration;
the sensing circuit connecting the at least one sensing strip via an amplifier, the amplifier being set to a first gain as the sensing circuit generating the first signal, the amplifier being set to a second gain as the sensing circuit generating the second signal, the first gain being different from the second gain;
the sensing circuit producing the first signal after a first delay phase difference, the sensing circuit producing the second signal after a second delay phase difference, the first delay phase difference being different from the second delay phase difference;
the potential of the first driving signal being different from the potential of the second driving signal;
a first driving time point for providing the first driving signal being different from a second driving time point for providing the second driving signal; and
the driving time duration of the first driving signal being different from the driving time duration of the second driving signal.

29. The method of claim 28, wherein a time duration ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

30. The method of claim 28, wherein a potential ratio of the driving time duration of the first driving signal to the driving time duration of the second driving signal corresponds to one of followings or the combination thereof:
an area ratio of the first set of the driving strips to the second set of the driving strips; and
an interval ratio of the interval between the first set of the driving strips and adjacent of the driving strips thereof to the interval between the second set of the driving strips and adjacent of the driving strips thereof.

31. The method of claim 28, wherein the first sensing time duration corresponds to the driving time duration of the first driving signal, the second sensing time duration corresponds to the driving time duration of the second driving signal.

32. The method of claim 31, wherein the first sensing time duration is equal to the driving time duration of the first driving signal, the second sensing time duration is equal to the driving time duration of the second driving signal, the first sensing time duration is different from the second sensing time duration.

33. The method of claim 31, wherein the first sensing time duration is longer than the driving time duration of the first driving signal, the second sensing time duration is longer than the driving time duration of the second driving signal.

34. The method of claim 28, wherein the first delay phase difference is different from the second delay phase difference.

35. A touch sensitive system, comprising:
a touch sensitive screen, comprising multiple conductive strips including multiple parallel driving strips and multiple parallel sensing strips, wherein multiple intersecting areas are located at multiple intersections of the driving and sensing strips; and
a signal-measuring apparatus, comprising:
a driving circuit, sequentially providing a first driving signal and a second driving signal to a first set of the driving strips and a second set of the driving strips, respectively; and
a sensing circuit, sequentially sensing a first signal and a second signal of at least one of sensing strips corresponding to the first driving signal and the second driving signal, respectively,
wherein the time duration of the first driving signal is different from the time duration of the second driving signal.
